(19) United States
(12) Patent Application Publication
(10) Pub. No.: US 2026/0011226 A1
(43) Pub. Date: Jan. 8, 2026

(54) SUGGESTED PROFILES

(71) Applicant: SimpliSafe, Inc., Boston, MA (US)

(72) Inventors: Jessica Pitocco, Arlington, MA (US); Nadeem Hussain, Worcester, MA (US); Alice Chiang, Arlington, MA (US)

(21) Appl. No.: 18/987,603

(22) Filed: Dec. 19, 2024

Related U.S. Application Data
(60) Provisional application No. 63/667,431, filed on Jul. 3, 2024.

(51) Int. Cl. G08B 13/196; G06V 20/52; H04L 67/306

(52) U.S. Cl. CPC G08B 13/196; G06V 20/52; H04L 67/306

(57) ABSTRACT

A computer system including a memory and a processor coupled with the memory. The processor is configured to suggest that a subject of a profile be authorized to access a location, receive confirmation that the subject is authorized to access the location, receive an image acquired at the location, the image depicting the subject, recognize the subject in the image, and refrain, in response to recognizing the subject and based on the profile, from initiating an alarm.

### CROSS-REFERENCE TO RELATED APPLICATION

This application claims priority under 35 U.S.C. § 119 (e) to co-pending U.S. Provisional Application No. 63/667,431, filed on Jul. 3, 2024 and titled “SUGGESTED PROFILES,” which is hereby incorporated herein by reference in its entirety.

### TECHNICAL FIELD

Aspects of the technologies described herein relate to security systems and methods.

### BACKGROUND

Some monitoring systems use one or more cameras to capture images of areas around or within a residence or business location. Such monitoring systems can process images locally and transmit the captured images to a remote service. If motion is detected, the monitoring systems can send an alert to one or more user devices.

### SUMMARY

This disclosure is directed to techniques for maintaining and suggesting profiles that enable a security system to autonomously identify subjects (e.g., persons) who are authorized to access a location.

In at least one example, a computer-implemented method is provided. The method includes suggesting, by a security system, that a subject of a profile be authorized to access a location; receiving, by the security system, confirmation that the subject is authorized to access the location; receiving, from an image capture device of a system, an image acquired at the location, the image depicting the subject; recognizing, by the security system, the subject in the image; and refraining, by the security system and based on the profile, from initiating an alarm in response to detecting the subject in the image.

In at least one example, a system including a memory and at least one processor coupled with the memory is provided. The at least one processor is configured to suggest that a subject of a profile be authorized to access a location, receive confirmation that the subject is authorized to access the location, receive an image acquired at the location, the image depicting the subject, recognize the subject in the image; and refrain, based on the profile, from initiating an alarm in response to detecting the subject in the image.

In at least one example, one or more non-transitory computer readable media are provided. The one or more non-transitory computer readable media store sequences of instructions executable by at least one processor to filter events based on profiles. The sequences of instructions include instructions to suggest that a subject of a profile be authorized to access a location, receive confirmation that the subject is authorized to access the location, receive an image acquired at the location, the image depicting the subject, recognize the subject in the image; and refrain, based on the profile, from initiating an alarm in response to detecting the subject in the image.

### BRIEF DESCRIPTION OF THE DRAWINGS

Additional examples of the disclosure, as well as features and advantages thereof, will become more apparent by reference to the description herein taken in conjunction with the accompanying drawings which are incorporated in and constitute a part of this disclosure. The figures are not necessarily drawn to scale.

FIG. 1 is a schematic diagram of a security system, according to some examples described herein.

FIG. 2 is a schematic diagram of a base station, according to some examples described herein.

FIG. 3 is a schematic diagram of a keypad, according to some examples described herein.

FIG. 4A is a schematic diagram of a security sensor, according to some examples described herein.

FIG. 4B is a schematic diagram of an image capture device, according to some examples described herein.

FIG. 4C is a schematic diagram of another image capture device, according to some examples described herein.

FIG. 5A is a schematic diagram of a data center environment, a monitoring center environment, and a customer device, according to some examples described herein.

FIG. 5B is another schematic diagram of a data center environment, a monitoring center environment, and a customer device, according to some examples described herein.

FIG. 6 is a sequence diagram of a monitoring process, according to some examples described herein.

FIG. 7 is a sequence diagram of process of configuring profiles, according to some examples described herein.

FIG. 8 is a flow diagram illustrating a process of administering a profile selection screen, according to some examples described herein.

FIG. 9 is a front view of a profile selection screen, according to some examples described herein.

FIG. 10 is a flow diagram illustrating a process of administering a profile editing screen, according to some examples described herein.

FIG. 11 is a front view of a profile editing screen, according to some examples described herein.

FIG. 12 is a flow diagram illustrating a process of suggesting and accepting profiles, according to some examples described herein.

FIG. 13 is a sequence diagram illustrating a process of configuring profiles, according to some examples described herein.

FIG. 14 is a schematic diagram of system features involved in profile suggestion processes, according to some examples described herein.

FIG. 15 is a sequence diagram illustrating a process of configuring profiles, according to some examples described herein.

FIG. 16 is a flow diagram illustrating a process of filtering using profiles, according to some examples described herein.

FIG. 17 is a schematic diagram of a computing device, according to some examples described herein.

### DETAILED DESCRIPTION

As summarized above, at least some examples disclosed herein are directed to systems and processes that maintain and suggest usage of profiles to identify individuals. In some examples, a profile includes one or more images (e.g., photographs) that depict the face of a subject, a list of locations the subject is authorized to access, and an indicator of a type of the profile. For instance, in certain examples, a profile is recorded as a data structure (e.g., a database record) with fields allocated to store the informational attributes listed above. The facial images included in the profile can be used to train facial recognition processes that utilize artificial intelligence (AI) models to recognize the subject of a profile. The list of locations can be used by customers to fine tune the applicability of the profiles to specific locations (e.g., customer locations). In some examples, profiles are used to determine whether potential threats (e.g., persons detected at a location) are actually benign (e.g., authorized to be at the location). As such, creation and use of a customer profile can change an event (e.g., the appearance of a person at a monitored location) that would normally be reportable to a customer and/or monitoring personnel to a non-reportable event.

Creation and use of profiles can yield a variety of benefits including reduction of unnecessary notifications (e.g., false alarms) sent to customers and/or monitoring personnel, conservation of system resources, and provision of actionable information as to who should, and who should not, be allowed to visit a location.

Profiles allow a system (e.g., a security system) to autonomously recognize and dispose of issues that might otherwise require handling by monitoring personnel. Moreover, even if a situation cannot be disposed of autonomously by a system, the presence of profiles provides monitoring personnel with additional information that can help them handle the situation quickly and efficiently. This can be particularly helpful if the system is large and can detect a high volume of events. Efficient and accurate processing of these events is helpful, if not required, to scale any monitoring service that surveils locations via the security system. In at least some examples disclosed herein, the profiles provide a solution to the technical challenge of resolving a high number of events detected at numerous monitored locations, as may be captured by cameras disposed both inside and outside of the monitored locations.

Underutilization of profiles can have detrimental effects. For example, some systems allow for the creation and maintenance of profiles that are not linked, or otherwise associated, with any physical locations. These “orphan profiles” consume compute and storage resources by their very existence, but the orphan profiles provide little to no value to the overall system because they are not available to monitoring personnel or AI systems to compare against individuals detected at physical locations. Orphan profiles can be particularly troublesome where the system supports a large number of users, each of whom may be linked, or otherwise associated, with multiple orphan profiles.

The risk of orphan profiles, as well as other issues, are addressed by at least some of the example systems and processes described herein. For instance, in at least one example, a graphical user interface (GUI) presents profiles that are linked, or otherwise associated, with a user available for selection by the user in screens that assign profiles to a location (e.g., a monitored location). Profiles that are recorded as allowed and that are linked, or otherwise associated, with a location are represented in the GUI as allowed profile controls and profiles recorded as allowed but not linked with the location are represented in the GUI as suggested profile controls. By presenting controls for all profiles linked to a user each time the user considers the topic of linking profiles to a location, the GUI helps prevent profiles from being forgotten, which can help in preventing orphan profiles.

To present as many profile controls as possible within the limited space of a single screen, some examples of the GUI maintain a currently selected location in context when rendering screens that address assignment of profiles. As referred to herein, the context of a user interface screen may include one or more selections made via user interface screens rendered prior to the current user interface screen. Maintenance of location context allows profile assignment screens to omit controls configured to select a location. For instance, the GUI may prompt the user to select a current location on a screen rendered prior to the profile assignment screens. The selected current location can then be maintained in context for subsequent profile assignment screens and operations. In some examples, this location-first approach is used consistently throughout the GUI (e.g., for operations other than profile assignment). These examples benefit from increased case of use by presenting screens involved in configuration of location information using a consistent location-first approach.

In some examples, the systems and processes described herein further require that profiles be linked to at least one monitored location. This constraint prevents orphan profiles from being created in the first instance. As is described further below, this constraint can be systematically enforced via screens included in the GUI, stored procedures, in the underlying data model, or through other technologies. Regardless of the manner of implementation, requiring that a profile be linked to at least one monitored location ensures that each profile provides some utility and is not simply wasted space.

Whereas various examples are described herein, it will be apparent to those of ordinary skill in the art that many more examples and implementations are possible. Accordingly, the examples described herein are not the only possible examples and implementations. Furthermore, the advantages described above are not necessarily the only advantages, and it is not necessarily expected that all of the described advantages will be achieved with every example.

For the purposes of promoting an understanding of the principles of the present disclosure, reference will now be made to the examples illustrated in the drawings, and specific language will be used to describe the same. It will nevertheless be understood that no limitation of the scope of the examples described herein is thereby intended.

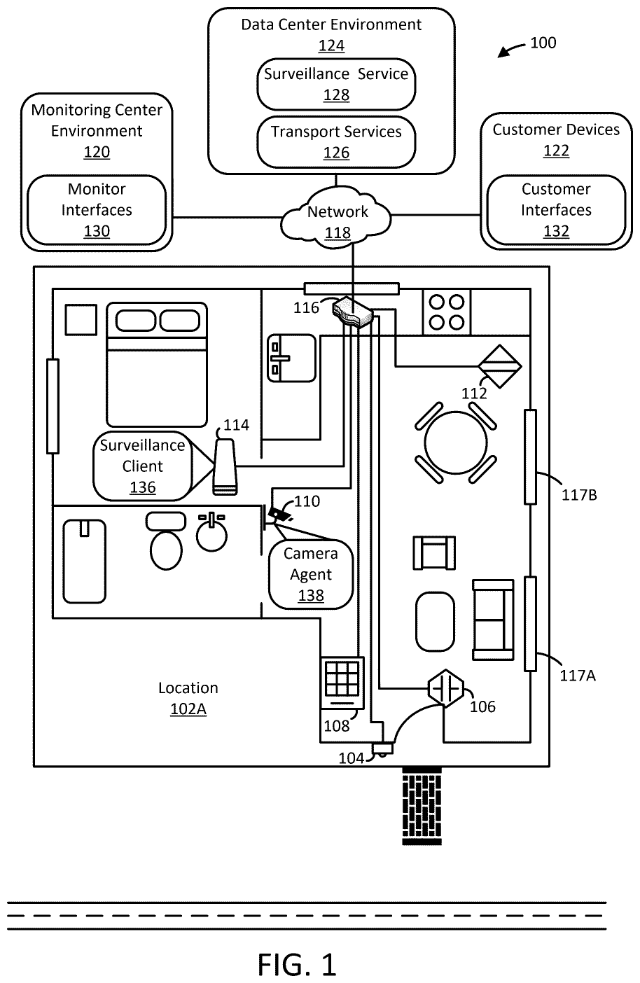

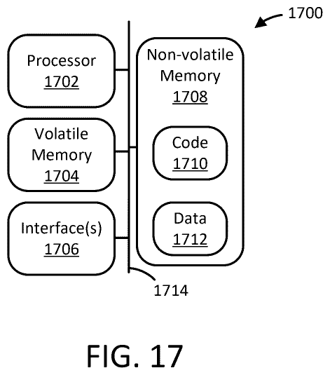

FIG. 1 is a schematic diagram of a security system 100 configured to monitor geographically disparate locations in accordance with some examples. As shown in FIG. 1, the system 100 includes a monitored location 102A, a monitoring center environment 120, a data center environment 124, one or more customer devices 122, and a communication network 118. Each of the monitored location 102A, the monitoring center environment 120, the data center environment 124, the one or more customer devices 122, and the communication network 118 include one or more computing devices (e.g., as described below with reference to FIG. 17). The one or more customer devices 122 are configured to host one or more customer interface applications 132. The monitoring center environment 120 is configured to host one or more monitor interface applications 130. The data center environment 124 is configured to host a surveillance service 128 and one or more transport services 126. The location 102A includes image capture devices 104 and 110, a contact sensor assembly 106, a keypad 108, a motion sensor assembly 112, a base station 114, and a router 116. The base station 114 hosts a surveillance client 136. The image capture device 110 hosts a camera agent 138. The security devices disposed at the location 102A (e.g., devices 104, 106, 108, 110, 112, and 114) may be referred to herein as location-based devices.

In some examples, the router 116 is a wireless router that is configured to communicate with the location-based devices via communications that comport with a communications standard such as any of the various Institute of Electrical and Electronics Engineers (IEEE) 802.11 standards. As illustrated in FIG. 1, the router 116 is also configured to communicate with the network 118. It should be noted that the router 116 implements a local area network (LAN) within and proximate to the location 102A by way of example only. Other networking technology that involves other computing devices is suitable for use within the location 102A. For instance, in some examples, the base station 114 can receive and forward communication packets transmitted by the image capture device 110 via a personal area network (PAN) protocol, such as BLUETOOTH. Additionally or alternatively, in some examples, the location-based devices communicate directly with one another using any of a variety of standards suitable for point-to-point use, such as any of the IEEE 802.11 standards, PAN standards, etc. In at least one example, the location-based devices can communicate with one another using a sub-GHz wireless networking standard, such as IEEE 802.11ah, Z-WAVE, ZIGBEE, etc. Other wired, wireless, and mesh network technology and topologies will be apparent with the benefit of this disclosure and are intended to fall within the scope of the examples disclosed herein.

Continuing with the example of FIG. 1, the network 118 can include one or more public and/or private networks that support, for example, IP. The network 118 may include, for example, one or more LANs, one or more PANs, and/or one or more wide area networks (WANs). The LANs can include wired or wireless networks that support various LAN standards, such as a version of IEEE 802.11 and the like. The PANs can include wired or wireless networks that support various PAN standards, such as BLUETOOTH, ZIGBEE, and the like. The WANs can include wired or wireless networks that support various WAN standards, such as the Code Division Multiple Access (CDMA) radio standard, the Global System for Mobiles (GSM) radio standard, and the like. The network 118 connects and enables data communication between the computing devices within the location 102A, the monitoring center environment 120, the data center environment 124, and the customer devices 122. In at least some examples, both the monitoring center environment 120 and the data center environment 124 include network equipment (e.g., similar to the router 116) that is configured to communicate with the network 118 and computing devices collocated with or near the network equipment. It should be noted that, in some examples, the network 118 and the network extant within the location 102A support other communication protocols, such as MQTT or other IoT protocols.

Continuing with the example of FIG. 1, the data center environment 124 can include physical space, communications, cooling, and power infrastructure to support networked operation of computing devices. For instance, this infrastructure can include rack space into which the computing devices are installed, uninterruptible power supplies, cooling plenum and equipment, and networking devices. The data center environment 124 can be dedicated to the security system 100, can be a non-dedicated, commercially available cloud computing service (e.g., MICROSOFT AZURE, AMAZON WEB SERVICES, GOOGLE CLOUD, or the like), or can include a hybrid configuration made up of dedicated and non-dedicated resources. Regardless of its physical or logical configuration, as shown in FIG. 1, the data center environment 124 is configured to host the surveillance service 128 and the transport services 126.

Continuing with the example of FIG. 1, the monitoring center environment 120 can include a plurality of computing devices (e.g., desktop computers) and network equipment (e.g., one or more routers) connected to the computing devices and the network 118. The customer devices 122 can include personal computing devices (e.g., a desktop computer, laptop, tablet, smartphone, or the like) and network equipment (e.g., a router, cellular modem, cellular radio, or the like). As illustrated in FIG. 1, the monitoring center environment 120 is configured to host the monitor interfaces 130 and the customer devices 122 are configured to host the customer interfaces 132.

Continuing with the example of FIG. 1, the devices 104, 106, 110, and 112 are configured to acquire analog signals via sensors incorporated into the devices, generate digital sensor data based on the acquired signals, and communicate (e.g., via a wireless link with the router 116) the sensor data to the base station 114. The type of sensor data generated and communicated by these devices varies along with the type of sensors included in the devices. For instance, the image capture devices 104 and 110 can acquire ambient light, generate frames of image data based on the acquired light, and communicate the frames to the base station 114, the monitor interfaces 130, and/or the customer interfaces 132, although the pixel resolution and frame rate may vary depending on the capabilities of the devices. Where the image capture devices 104 and 110 have sufficient processing capacity and available power, the image capture devices 104 and 110 can process the image frames and transmit messages based on content depicted in the image frames, as described further below. These messages may specify reportable events and may be transmitted in place of, or in addition to, the image frames. Such messages may be sent directly to another location-based device (e.g., via sub-GHz networking) and/or indirectly to any device within the system 100 (e.g., via the router 116). As shown in FIG. 1, the image capture device 104 has a field of view (FOV) that originates proximal to a front door of the location 102A and can acquire images of a walkway, highway, and a space between the location 102A and the highway. The image capture device 110 has an FOV that originates proximal to a bathroom of the location 102A and can acquire images of a living room and dining area of the location 102A. The image capture device 110 can further acquire images of outdoor areas beyond the location 102A through windows 117A and 117B on the right side of the location 102A.

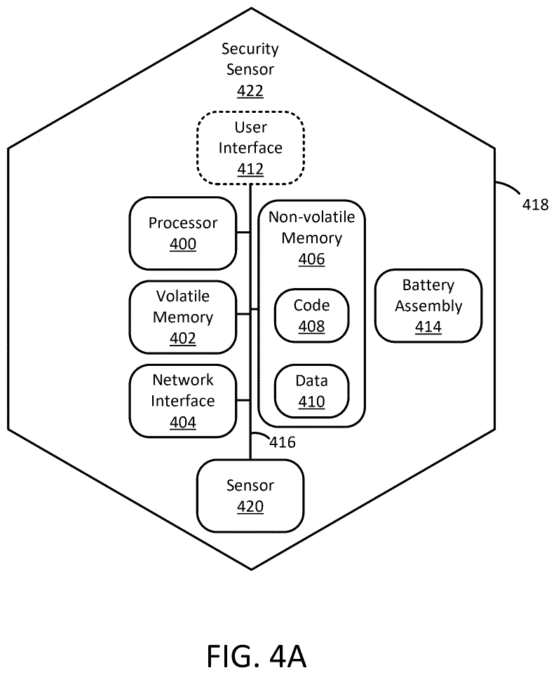

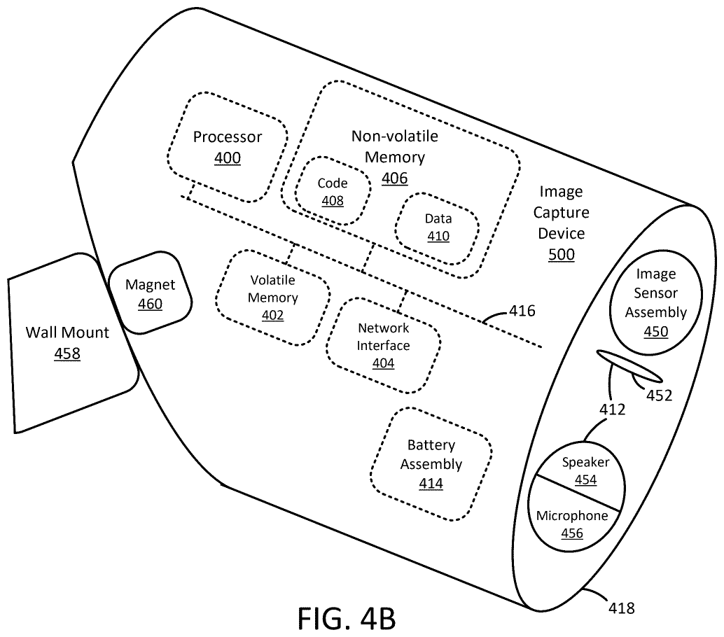

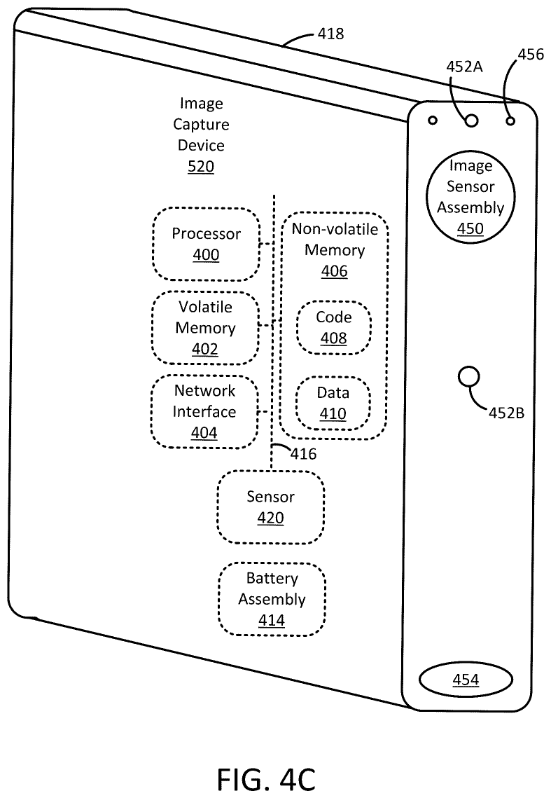

Further, as shown in FIG. 1, in some examples the image capture device 110 is configured to communicate with the surveillance service 128, the monitor interfaces 130, and the customer interfaces 132 separately from the surveillance client 136 via execution of the camera agent 138. These communications can include sensor data generated by the image capture device 110 and/or commands to be executed by the image capture device 110 sent by the surveillance service 128, the monitor interfaces 130, and/or the customer interfaces 132. The commands can include, for example, requests for interactive communication sessions in which monitoring personnel and/or customers interact with the image capture device 110 via the monitor interfaces 130 and the customer interfaces 132. These interactions can include requests for the image capture device 110 to transmit additional sensor data and/or requests for the image capture device 110 to render output via a user interface (e.g., the user interface 412 of FIGS. 4B and 4C). This output can include audio and/or video output.

Continuing with the example of FIG. 1, the contact sensor assembly 106 includes a sensor that can detect the presence or absence of a magnetic field generated by a magnet when the magnet is proximal to the sensor. When the magnetic field is present, the contact sensor assembly 106 generates Boolean sensor data specifying a closed state. When the magnetic field is absent, the contact sensor assembly 106 generates Boolean sensor data specifying an open state. In either case, the contact sensor assembly 106 can communicate sensor data indicating whether the front door of the location 102A is open or closed to the base station 114. The motion sensor assembly 112 can include an audio emission device that can radiate sound (e.g., ultrasonic) waves and an audio sensor that can acquire reflections of the waves. When the audio sensor detects the reflection because no objects are in motion within the space monitored by the audio sensor, the motion sensor assembly 112 generates Boolean sensor data specifying a still state. When the audio sensor does not detect a reflection because an object is in motion within the monitored space, the motion sensor assembly 112 generates Boolean sensor data specifying an alarm state. In either case, the motion sensor assembly 112 can communicate the sensor data to the base station 114. It should be noted that the specific sensing modalities described above are not limiting to the present disclosure. For instance, as one of many potential examples, the motion sensor assembly 112 can base its operation on acquisition of changes in temperature rather than changes in reflected sound waves.

Continuing with the example of FIG. 1, the keypad 108 is configured to interact with a user and interoperate with the other location-based devices in response to interactions with the user. For instance, in some examples, the keypad 108 is configured to receive input from a user that specifies one or more commands and to communicate the specified commands to one or more addressed processes. These addressed processes can include processes implemented by one or more of the location-based devices and/or one or more of the monitor interfaces 130 or the surveillance service 128. The commands can include, for example, codes that authenticate the user as a resident of the location 102A and/or codes that request activation or deactivation of one or more of the location-based devices. Alternatively or additionally, in some examples, the keypad 108 includes a user interface (e.g., a tactile interface, such as a set of physical buttons or a set of virtual buttons on a touchscreen) configured to interact with a user (e.g., receive input from and/or render output to the user). Further still, in some examples, the keypad 108 can receive and respond to the communicated commands and render the responses via the user interface as visual or audio output.

Continuing with the example of FIG. 1, the base station 114 is configured to interoperate with the other location-based devices to provide local command and control and store-and-forward functionality via execution of the surveillance client 136. In some examples, to implement store-and-forward functionality, the base station 114, through execution of the surveillance client 136, receives sensor data, packages the data for transport, and stores the packaged sensor data in local memory for subsequent communication. This communication of the packaged sensor data can include, for instance, transmission of the packaged sensor data as a payload of a message to one or more of the transport services 126 when a communication link to the transport services 126 via the network 118 is operational. In some examples, packaging the sensor data can include filtering the sensor data and/or generating one or more summaries (maximum values, minimum values, average values, changes in values since the previous communication of the same, etc.) of multiple sensor readings. To implement local command and control functionality, the base station 114 executes, under control of the surveillance client 136, a variety of programmatic operations in response to various events. Examples of these events can include reception of commands from the keypad 108 or the customer interface application 132, reception of commands from one of the monitor interfaces 130 or the customer interface application 132 via the network 118, or detection of the occurrence of a scheduled event. The programmatic operations executed by the base station 114 under control of the surveillance client 136 can include activation or deactivation of one or more of the devices 104, 106, 108, 110, and 112; sounding of an alarm; reporting an event to the surveillance service 128; and communicating location data to one or more of the transport services 126 to name a few operations. The location data can include data specifying sensor readings (sensor data), configuration data of any of the location-based devices, commands input and received from a user (e.g., via the keypad 108 or a customer interface 132), or data derived from one or more of these data types (e.g., filtered sensor data, summarizations of sensor data, event data specifying an event detected at the location via the sensor data, etc.).

Continuing with the example of FIG. 1, the transport services 126 are configured to securely, reliably, and efficiently exchange messages between processes implemented by the location-based devices and processes implemented by other devices in the system 100. These other devices can include the customer devices 122, devices disposed in the data center environment 124, and/or devices disposed in the monitoring center environment 120. In some examples, the transport services 126 are also configured to parse messages from the location-based devices to extract payloads included therein and store the payloads and/or data derived from the payloads within one or more data stores hosted in the data center environment 124. The data housed in these data stores may be subsequently accessed by, for example, the surveillance service 128, the monitor interfaces 130, and the customer interfaces 132. It should be noted that data stored within any of the data stores disclosed herein may be stored by value or by reference (e.g., via an pointer, address, or other identifier of the data or the data's location).

In certain examples, the transport services 126 expose and implement one or more application programming interfaces (APIs) that are configured to receive, process, and respond to calls from processes (e.g., the surveillance client 136) implemented by base stations (e.g., the base station 114) and/or processes (e.g., the camera agent 138) implemented by other devices (e.g., the image capture device 110). Individual instances of a transport service within the transport services 126 can be associated with and specific to certain manufactures and models of location-based monitoring equipment (e.g., SIMPLISAFE equipment, RING equipment, etc.). The APIs can be implemented using a variety of architectural styles and interoperability standards. For instance, in one example, the API is a web services interface implemented using a representational state transfer (REST) architectural style. In this example, API calls are encoded in Hypertext Transfer Protocol (HTTP) along with JavaScript Object Notation (JSON) and/or extensible markup language (XML). These API calls are addressed to one or more uniform resource locators (URLs) that are API endpoints monitored by the transport services 126. In some examples, portions of the HTTP communications are encrypted to increase security. Alternatively or additionally, in some examples, the API is implemented as an MQTT broker that receives messages and transmits responsive messages to MQTT clients hosted by the base stations and/or the other devices. Alternatively or additionally, in some examples, the API is implemented using simple file transfer protocol commands. Thus, the transport services 126 are not limited to a particular protocol or architectural style. It should be noted that, in at least some examples, the transport services 126 can transmit one or more API calls to location-based devices to request data from, or an interactive communication session with, the location-based devices.

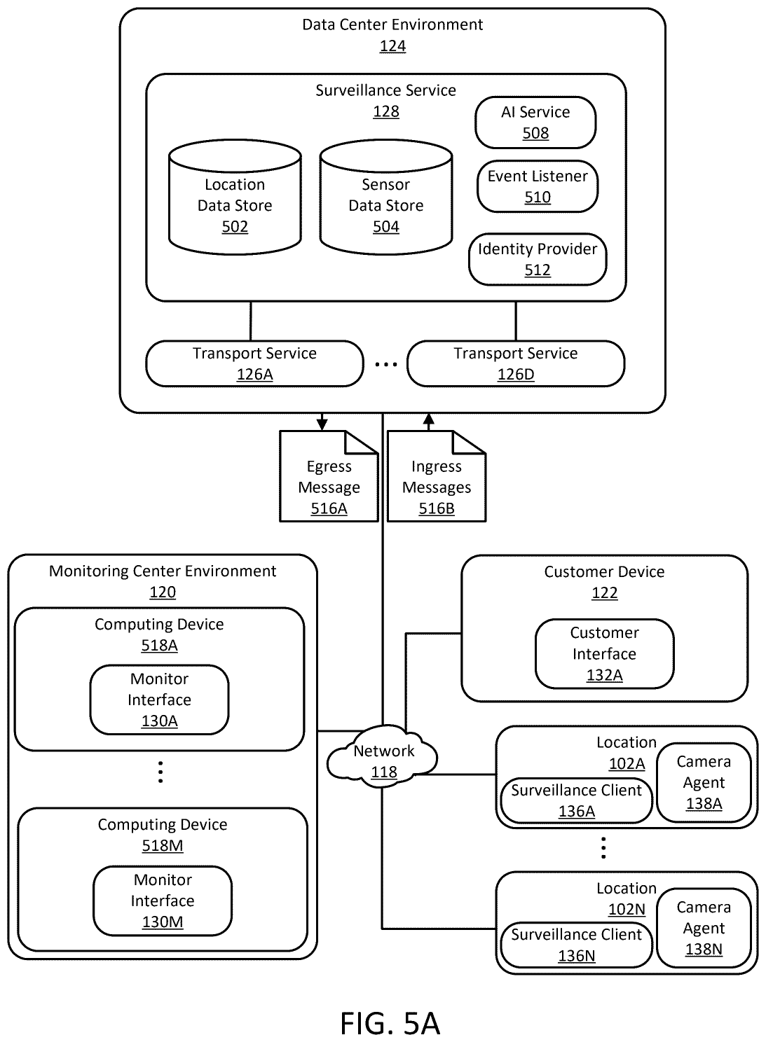

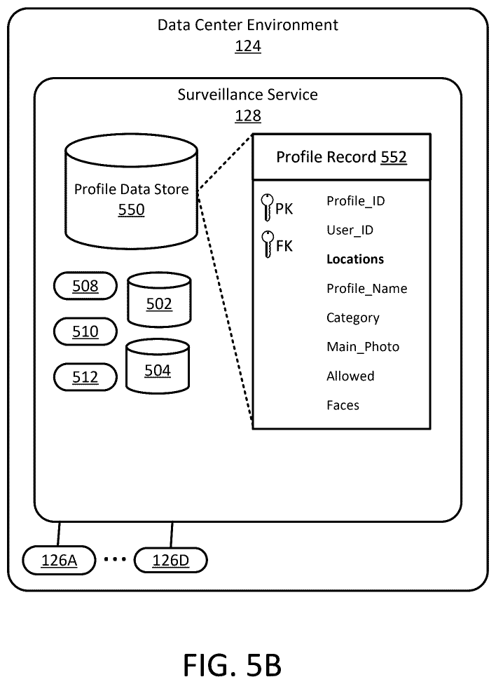

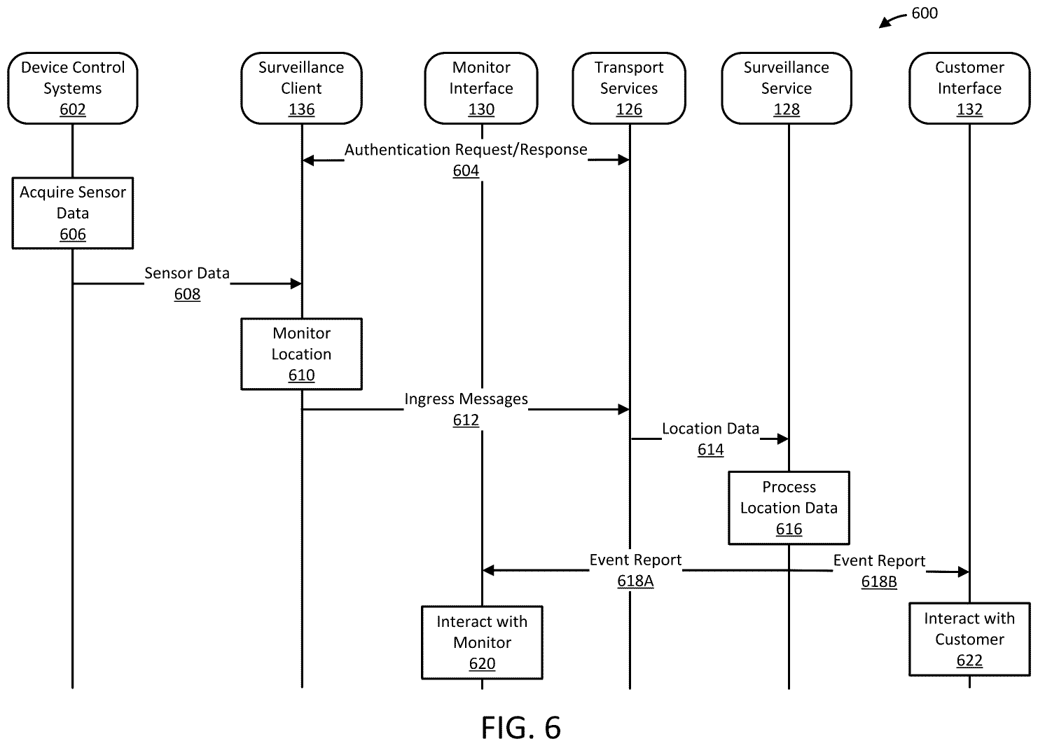

Continuing with the example of FIG. 1, the surveillance service 128 is configured to control overall logical setup and operation of the system 100. As such, the surveillance service 128 can interoperate with the transport services 126, the monitor interfaces 130, the customer interfaces 132, and any of the location-based devices. In some examples, the surveillance service 128 is configured to monitor data from a variety of sources for reportable events (e.g., a break-in event) and, when a reportable event is detected, notify one or more of the monitor interfaces 130 and/or the customer interfaces 132 of the reportable event. In some examples, the surveillance service 128 is also configured to maintain state information regarding the location 102A. This state information can indicate, for instance, whether the location 102A is safe or under threat. In certain examples, the surveillance service 128 is configured to change the state information to indicate that the location 102A is safe only upon receipt of a communication indicating a clear event (e.g., rather than making such a change in response to discontinuation of reception of break-in events). This feature can prevent a “crash and smash” robbery from being successfully executed. Further example processes that the surveillance service 128 is configured to execute are described below with reference to FIGS. 5A, 5B, and 6.

Continuing with the example of FIG. 1, individual monitor interfaces 130 are configured to control computing device interaction with monitoring personnel and to execute a variety of programmatic operations in response to the interactions. For instance, in some examples, the monitor interface 130 controls its host device to provide information regarding reportable events detected at monitored locations, such as the location 102A, to monitoring personnel. Such events can include, for example, movement or an alarm condition generated by one or more of the location-based devices. Alternatively or additionally, in some examples, the monitor interface 130 controls its host device to interact with a user to configure features of the system 100. Further example processes that the monitor interface 130 is configured to execute are described below with reference to FIG. 6. It should be noted that, in at least some examples, the monitor interfaces 130 are browser-based applications served to the monitoring center environment 120 by webservers included within the data center environment 124. These webservers may be part of the surveillance service 128, in certain examples.

Continuing with the example of FIG. 1, individual customer interfaces 132 are configured to control computing device interaction with a customer and to execute a variety of programmatic operations in response to the interactions. For instance, in some examples, the customer interface 132 controls its host device to provide information regarding reportable events detected at monitored locations, such as the location 102A, to the customer. Such events can include, for example, an alarm condition generated by one or more of the location-based devices. Alternatively or additionally, in some examples, the customer interface 132 is configured to process input received from the customer to activate or deactivate one or more of the location-based devices. Further still, in some examples, the customer interface 132 configures features of the system 100 in response to input from a user. Further example processes that the customer interface 132 is configured to execute are described below with reference to FIG. 6.

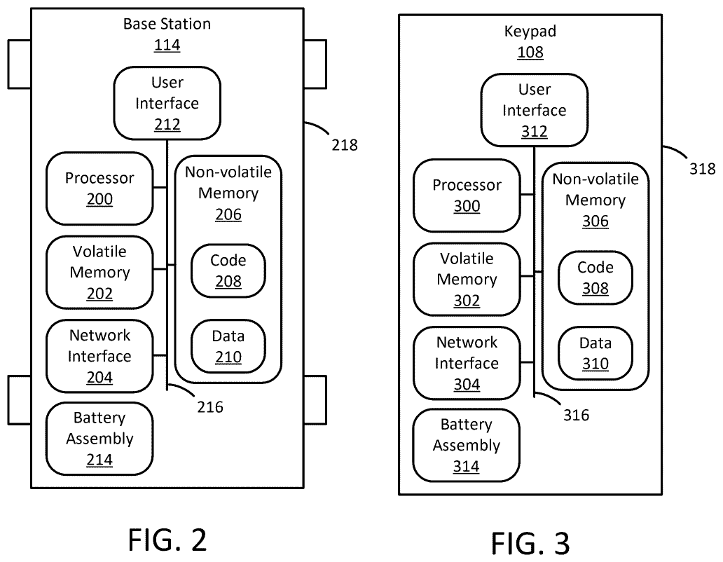

Turning now to FIG. 2, an example base station 114 is schematically illustrated. As shown in FIG. 2, the base station 114 includes at least one processor 200, volatile memory 202, non-volatile memory 206, at least one network interface 204, a user interface 212, a battery assembly 214, and an interconnection mechanism 216. The non-volatile memory 206 stores executable code 208 and includes a data store 210. In some examples illustrated by FIG. 2, the features of the base station 114 enumerated above are incorporated within, or are a part of, a housing 218.

In some examples, the non-volatile (non-transitory) memory 206 includes one or more read-only memory (ROM) chips; one or more hard disk drives or other magnetic or optical storage media; one or more solid state drives (SSDs), such as a flash drive or other solid-state storage media; and/or one or more hybrid magnetic and SSDs. In certain examples, the code 208 stored in the non-volatile memory can include an operating system and one or more applications or programs that are configured to execute under the operating system. Alternatively or additionally, the code 208 can include specialized firmware and embedded software that is executable without dependence upon a commercially available operating system. Regardless, execution of the code 208 can implement the surveillance client 136 of FIG. 1 and can result in manipulated data that is a part of the data store 210.

Continuing with the example of FIG. 2, the processor 200 can include one or more programmable processors to execute one or more executable instructions, such as a computer program specified by the code 208, to control the operations of the base station 114. As used herein, the term “processor” describes circuitry that executes a function, an operation, or a sequence of operations. The function, operation, or sequence of operations can be hard coded into the circuitry or soft coded by way of instructions held in a memory device (e.g., the volatile memory 202) and executed by the circuitry. In some examples, the processor 200 is a digital processor, but the processor 200 can be analog, digital, or mixed. As such, the processor 200 can execute the function, operation, or sequence of operations using digital values and/or using analog signals. In some examples, the processor 200 can be embodied in one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), or multicore processors. Examples of the processor 200 that are multicore can provide functionality for parallel, simultaneous execution of instructions or for parallel, simultaneous execution of one instruction on more than one piece of data.

Continuing with the example of FIG. 2, prior to execution of the code 208 the processor 200 can copy the code 208 from the non-volatile memory 206 to the volatile memory 202. In some examples, the volatile memory 202 includes one or more static or dynamic random access memory (RAM) chips and/or cache memory (e.g., memory disposed on a silicon die of the processor 200). Volatile memory 202 can offer a faster response time than a main memory, such as the non-volatile memory 206.

Through execution of the code 208, the processor 200 can control operation of the network interface 204. For instance, in some examples, the network interface 204 includes one or more physical interfaces (e.g., a radio, an ethernet port, a universal serial bus (USB) port, etc.) and a software stack including drivers and/or other code 208 that is configured to communicate with the one or more physical interfaces to support one or more LAN, PAN, and/or WAN standard communication protocols. The communication protocols can include, for example, transmission control protocol (TCP), user datagram protocol (UDP), HTTP, and MQTT among others. As such, the network interface 204 enables the base station 114 to access and communicate with other computing devices (e.g., the location-based devices) via a computer network (e.g., the LAN established by the router 116 of FIG. 1, the network 118 of FIG. 1, and/or a point-to-point connection). For instance, in at least one example, the network interface 204 utilizes sub-GHz wireless networking to transmit messages to other location-based devices. These messages can include wake messages to request streams of sensor data, alarm messages to trigger alarm responses, or other messages to initiate other operations. Bands that the network interface 204 may utilize for sub-GHz wireless networking include, for example, an 868 MHz band and/or a 915 MHz band. Use of sub-GHz wireless networking can improve operable communication distances and/or reduce power consumed to communicate.

Through execution of the code 208, the processor 200 can control operation of the user interface 212. For instance, in some examples, the user interface 212 includes user input and/or output devices (e.g., a keyboard, a mouse, a touchscreen, a display, a speaker, a camera, an accelerometer, a biometric scanner, an environmental sensor, etc.) and a software stack including drivers and/or other code 208 that is configured to communicate with the user input and/or output devices. For instance, the user interface 212 can be implemented by a customer device 122 hosting a mobile application (e.g., a customer interface 132). The user interface 212 enables the base station 114 to interact with users to receive input and/or render output. This rendered output can include, for instance, one or more graphical user interfaces (GUIs) including one or more controls configured to display output and/or receive input. The input can specify values to be stored in the data store 210. The output can indicate values stored in the data store 210. It should be noted that, in some examples, parts of the user interface 212 are accessible and/or visible as part of, or through, the housing 218. These parts of the user interface 212 can include, for example, one or more light-emitting diodes (LEDs). Alternatively or additionally, in some examples, the user interface 212 includes a 95 dB siren that the processor 200 sounds to indicate that a break-in event has been detected.

Continuing with the example of FIG. 2, the various features of the base station 114 described above can communicate with one another via the interconnection mechanism 216. In some examples, the interconnection mechanism 216 includes a communications bus. In addition, in some examples, the battery assembly 214 is configured to supply operational power to the various features of the base station 114 described above. In some examples, the battery assembly 214 includes at least one rechargeable battery (e.g., one or more NiMH or lithium batteries). In some examples, the rechargeable battery has a runtime capacity sufficient to operate the base station 114 for 24 hours or longer while the base station 114 is disconnected from or otherwise not receiving line power. Alternatively or additionally, in some examples, the battery assembly 214 includes power supply circuitry to receive, condition, and distribute line power to both operate the base station 114 and recharge the rechargeable battery. The power supply circuitry can include, for example, a transformer and a rectifier, among other circuitry, to convert AC line power to DC device and recharging power.

Turning now to FIG. 3, an example keypad 108 is schematically illustrated. As shown in FIG. 3, the keypad 108 includes at least one processor 300, volatile memory 302, non-volatile memory 306, at least one network interface 304, a user interface 312, a battery assembly 314, and an interconnection mechanism 316. The non-volatile memory 306 stores executable code 308 and a data store 310. In some examples illustrated by FIG. 3, the features of the keypad 108 enumerated above are incorporated within, or are a part of, a housing 318.

In some examples, the respective descriptions of the processor 200, the volatile memory 202, the non-volatile memory 206, the interconnection mechanism 216, and the battery assembly 214 with reference to the base station 114 are applicable to the processor 300, the volatile memory 302, the non-volatile memory 306, the interconnection mechanism 316, and the battery assembly 314 with reference to the keypad 108. As such, those descriptions will not be repeated.

Continuing with the example of FIG. 3, through execution of the code 308, the processor 300 can control operation of the network interface 304. In some examples, the network interface 304 includes one or more physical interfaces (e.g., a radio, an ethernet port, a USB port, etc.) and a software stack including drivers and/or other code 308 that is configured to communicate with the one or more physical interfaces to support one or more LAN, PAN, and/or WAN standard communication protocols. These communication protocols can include, for example, TCP, UDP, HTTP, and MQTT among others. As such, the network interface 304 enables the keypad 108 to access and communicate with other computing devices (e.g., the other location-based devices) via a computer network (e.g., the LAN established by the router 116 and/or a point-to-point connection).

Continuing with the example of FIG. 3, through execution of the code 308, the processor 300 can control operation of the user interface 312. In some examples, the user interface 312 includes user input and/or output devices (e.g., physical keys arranged as a keypad, a touchscreen, a display, a speaker, a camera, a biometric scanner, an environmental sensor, etc.) and a software stack including drivers and/or other code 308 that is configured to communicate with the user input and/or output devices. As such, the user interface 312 enables the keypad 108 to interact with users to receive input and/or render output. This rendered output can include, for instance, one or more GUIs including one or more controls configured to display output and/or receive input. The input can specify values to be stored in the data store 310. The output can indicate values stored in the data store 310. It should be noted that, in some examples, parts of the user interface 312 (e.g., one or more LEDs) are accessible and/or visible as part of, or through, the housing 318.

In some examples, devices like the keypad 108, which rely on user input to trigger an alarm condition, may be included within a security system, such as the security system 100 of FIG. 1. Examples of such devices include dedicated key fobs and panic buttons. These dedicated security devices provide a user with a simple, direct way to trigger an alarm condition, which can be particularly helpful in times of duress.

Turning now to FIG. 4A, an example security sensor 422 is schematically illustrated. Particular configurations of the security sensor 422 (e.g., the image capture devices 104 and 110, the motion sensor assembly 112, and the contact sensor assemblies 106) are illustrated in FIG. 1 and described above. Other examples of security sensors 422 include glass break sensors, carbon monoxide sensors, smoke detectors, water sensors, temperature sensors, and door lock sensors, to name a few. As shown in FIG. 4A, the security sensor 422 includes at least one processor 400, volatile memory 402, non-volatile memory 406, at least one network interface 404, a battery assembly 414, an interconnection mechanism 416, and at least one sensor assembly 420. The non-volatile memory 406 stores executable code 408 and a data store 410. Some examples include a user interface 412. As indicated by its rendering in dashed lines, not all examples of the security sensor 422 include the user interface 412. In certain examples illustrated by FIG. 4A, the features of the security sensor 422 enumerated above are incorporated within, or are a part of, a housing 418.

In some examples, the respective descriptions of the processor 200, the volatile memory 202, the non-volatile memory 206, the interconnection mechanism 216, and the battery assembly 214 with reference to the base station 114 are applicable to the processor 400, the volatile memory 402, the non-volatile memory 406, the interconnection mechanism 416, and the battery assembly 414 with reference to the security sensor 422. As such, those descriptions will not be repeated.

Continuing with the example of FIG. 4A, through execution of the code 408, the processor 400 can control operation of the network interface 404. In some examples, the network interface 404 includes one or more physical interfaces (e.g., a radio (including an antenna), an ethernet port, a USB port, etc.) and a software stack including drivers and/or other code 408 that is configured to communicate with the one or more physical interfaces to support one or more LAN, PAN, and/or WAN standard communication protocols. The communication protocols can include, for example, TCP, UDP, HTTP, and MQTT among others. As such, the network interface 404 enables the security sensor 422 to access and communicate with other computing devices (e.g., the other location-based devices) via a computer network (e.g., the LAN established by the router 116 and/or a point-to-point connection). For instance, in at least one example, when executing the code 408, the processor 400 controls the network interface to stream (e.g., via UDP) sensor data acquired from the sensor assembly 420 to the base station 114. Alternatively or additionally, in at least one example, through execution of the code 408, the processor 400 can control the network interface 404 to enter a power conservation mode by powering down a 2.4 GHz radio and powering up a sub-GHz radio that are both included in the network interface 404. In this example, through execution of the code 408, the processor 400 can control the network interface 404 to enter a streaming or interactive mode by powering up a 2.4 GHz radio and powering down a sub-GHz radio, for example, in response to receiving a wake signal from the base station via the sub-GHz radio.

Continuing with the example of FIG. 4A, through execution of the code 408, the processor 400 can control operation of the user interface 412. In some examples, the user interface 412 includes user input and/or output devices (e.g., physical buttons, a touchscreen, a display, a speaker, a camera, an accelerometer, a biometric scanner, an environmental sensor, one or more LEDs, etc.) and a software stack including drivers and/or other code 408 that is configured to communicate with the user input and/or output devices. As such, the user interface 412 enables the security sensor 422 to interact with users to receive input and/or render output. This rendered output can include, for instance, one or more GUIs including one or more controls configured to display output and/or receive input. The input can specify values to be stored in the data store 410. The output can indicate values stored in the data store 410. It should be noted that, in some examples, parts of the user interface 412 are accessible and/or visible as part of, or through, the housing 418.

Continuing with the example of FIG. 4A, the sensor assembly 420 can include one or more types of sensors, such as the sensors described above with reference to the image capture devices 104 and 110, the motion sensor assembly 112, and the contact sensor assembly 106 of FIG. 1, or other types of sensors. For instance, in at least one example, the sensor assembly 420 includes an image sensor (e.g., a charge-coupled device or an active-pixel sensor) and/or a temperature or thermographic sensor (e.g., an active and/or passive infrared (PIR) sensor). Regardless of the type of sensor or sensors housed, the processor 400 can (e.g., via execution of the code 408) acquire sensor data from the housed sensor and stream the acquired sensor data to the processor 400 for communication to the base station.

It should be noted that, in some examples of the devices 108 and 422, the operations executed by the processors 300 and 400 while under control of respective control of the code 308 and 408 may be hardcoded and/or implemented in hardware, rather than as a combination of hardware and software. Moreover, execution of the code 408 can implement the camera agent 138 of FIG. 1 and can result in manipulated data that is a part of the data store 410.

Turning now to FIG. 4B, an example image capture device 500 is schematically illustrated. Particular configurations of the image capture device 500 (e.g., the image capture devices 104 and 110) are illustrated in FIG. 1 and described above. As shown in FIG. 4B, the image capture device 500 includes at least one processor 400, volatile memory 402, non-volatile memory 406, at least one network interface 404, a battery assembly 414, and an interconnection mechanism 416. These features of the image capture device 500 are illustrated in dashed lines to indicate that they reside within a housing 418. The non-volatile memory 406 stores executable code 408 and a data store 410.

Some examples further include an image sensor assembly 450, a light 452, a speaker 454, a microphone 456, a wall mount 458, and a magnet 460. The image sensor assembly 450 may include a lens and an image sensor (e.g., a charge-coupled device or an active-pixel sensor) and/or a temperature or thermographic sensor (e.g., an active and/or passive infrared (PIR) sensor). The light 452 may include a light emitting diode (LED), such as a red-green-blue emitting LED. The light 452 may also include an infrared emitting diode in some examples. The speaker 454 may include a transducer configured to emit sound in the range of 60 dB to 80 dB or louder. Further, in some examples, the speaker 454 can include a siren configured to emit sound in the range of 70 dB to 90 dB or louder. The microphone 456 may include a micro electro-mechanical system (MEMS) microphone. The wall mount 458 may include a mounting bracket, configured to accept screws or other fasteners that adhere the bracket to a wall, and a cover configured to mechanically couple to the mounting bracket. In some examples, the cover is composed of a magnetic material, such as aluminum or stainless steel, to enable the magnet 460 to magnetically couple to the wall mount 458, thereby holding the image capture device 500 in place.

In some examples, the respective descriptions of the processor 400, the volatile memory 402, the network interface 404, the non-volatile memory 406, the code 408 with respect to the network interface 404, the interconnection mechanism 416, and the battery assembly 414 with reference to the security sensor 422 are applicable to these same features with reference to the image capture device 500. As such, those descriptions will not be repeated here.

Continuing with the example of FIG. 4B, through execution of the code 408, the processor 400 can control operation of the image sensor assembly 450, the light 452, the speaker 454, and the microphone 456. For instance, in at least one example, when executing the code 408, the processor 400 controls the image sensor assembly 450 to acquire sensor data, in the form of image data, to be streamed to the base station 114 (or one of the processes 130, 128, or 132 of FIG. 1) via the network interface 404. Alternatively or additionally, in at least one example, through execution of the code 408, the processor 400 controls the light 452 to emit light so that the image sensor assembly 450 collects sufficient reflected light to compose the image data. Further, in some examples, through execution of the code 408, the processor 400 controls the speaker 454 to emit sound. This sound may be locally generated (e.g., a sonic alarm via the siren) or streamed from the base station 114 (or one of the processes 130, 128, or 132 of FIG. 1) via the network interface 404 (e.g., utterances from the user or monitoring personnel). Further still, in some examples, through execution of the code 408, the processor 400 controls the microphone 456 to acquire sensor data in the form of sound for streaming to the base station 114 (or one of the processes 130, 128, or 132 of FIG. 1) via the network interface 404.

It should be appreciated that in the example of FIG. 4B, the light 452, the speaker 454, and the microphone 456 implement an instance of the user interface 412 of FIG. 4A. It should also be appreciated that the image sensor assembly 450 and the light 452 implement an instance of the sensor assembly 420 of FIG. 4A. As such, the image capture device 500 illustrated in FIG. 4B is at least one example of the security sensor 422 illustrated in FIG. 4A. The image capture device 500 may be a battery-powered outdoor sensor configured to be installed and operated in an outdoor environment, such as outside a home, office, store, or other commercial or residential building, for example.

Turning now to FIG. 4C, another example image capture device 520 is schematically illustrated. Particular configurations of the image capture device 520 (e.g., the image capture devices 104 and 110) are illustrated in FIG. 1 and described above. As shown in FIG. 4C, the image capture device 520 includes at least one processor 400, volatile memory 402, non-volatile memory 406, at least one network interface 404, a battery assembly 414, and an interconnection mechanism 416. These features of the image capture device 520 are illustrated in dashed lines to indicate that they reside within a housing 418. The non-volatile memory 406 stores executable code 408 and a data store 410. The image capture device 520 further includes an image sensor assembly 450, a speaker 454, and a microphone 456 as described above with reference to the image capture device 500 of FIG. 4B.

In some examples, the image capture device 520 further includes lights 452A and 452B. The light 452A may include a light emitting diode (LED), such as a red-green-blue emitting LED. The light 452B may also include an infrared emitting diode to enable night vision in some examples.

It should be appreciated that in the example of FIG. 4C, the lights 452A and 452B, the speaker 454, and the microphone 456 implement an instance of the user interface 412 of FIG. 4A. It should also be appreciated that the image sensor assembly 450 and the light 452 implement an instance of the sensor assembly 420 of FIG. 4A. As such, the image capture device 520 illustrated in FIG. 4C is at least one example of the security sensor 422 illustrated in FIG. 4A. The image capture device 520 may be a battery-powered indoor sensor configured to be installed and operated in an indoor environment, such as within a home, office, store, or other commercial or residential building, for example.

Turning now to FIG. 5A, aspects of the data center environment 124 of FIG. 1, the monitoring center environment 120 of FIG. 1, one of the customer devices 122 of FIG. 1, the network 118 of FIG. 1, and a plurality of monitored locations 102A through 102N of FIG. 1 (collectively referred to as the locations 102) are schematically illustrated. As shown in FIG. 5A, the data center environment 124 hosts the surveillance service 128 and the transport services 126 (individually referred to as the transport services 126A through 126D). The surveillance service 128 includes a location data store 502, a sensor data store 504, an artificial intelligence (AI) service 508, an event listening service 510, and an identity provider 512. The monitoring center environment 120 includes computing devices 518A through 518M (collectively referred to as the computing devices 518) that host monitor interfaces 130A through 130M. Individual locations 102A through 102N include base stations (e.g., the base station 114 of FIG. 1, not shown) that host the surveillance clients 136A through 136N (collectively referred to as the surveillance clients 136) and image capture devices (e.g., the image capture device 110 of FIG. 1, not shown) that host the software camera agents 138A through 138N (collectively referred to as the camera agents 138). M and N may be any integer numbers greater than 1, and may be the same or different.

As shown in FIG. 5A, the transport services 126 are configured to process ingress messages 516B from the customer interface 132A, the surveillance clients 136, the camera agents 138, and/or the monitor interfaces 130. The transport services 126 are also configured to process egress messages 516A addressed to the customer interface 132A, the surveillance clients 136, the camera agents 138, and the monitor interfaces 130. The location data store 502 is configured to store, within a plurality of records, location data in association with identifiers of customers (e.g., user account identifiers) for whom the location is monitored. For example, the location data may be stored in a record with an identifier of a customer and/or an identifier of the location to associate the location data with the customer and the location. The sensor data store 504 is configured to store, within a plurality of records, sensor data (e.g., one or more frames of image data) separately from other location data but in association with identifiers of locations and timestamps at which the sensor data was acquired. In some examples, the sensor data store 504 is optional and may be used, for example, where the sensor data housed therein has specialized storage or processing requirements.

Continuing with the example of FIG. 5A, the AI service 508 is configured to process sensor data (e.g., images and/or sequences of images) to identify movement, human faces, and other features within the sensor data. In some examples, the AI service returns a classification of the sensor data and a metric indicative of a level of confidence that the classification is correct. The event listening service 510 is configured to scan location data transported via the ingress messages 516B for event data and, where event data is identified, execute one or more event handlers to process the event data. In some examples, the event handlers can include an event reporter that is configured to identify reportable events and to communicate messages specifying the reportable events to one or more recipient processes (e.g., a customer interface 132 and/or a monitor interface 130). In some examples, the event listening service 510 can interoperate with the AI service 508 to identify events from sensor data. The identity provider 512 is configured to receive, via the transport services 126, authentication requests from the surveillance clients 136 or the camera agents 138 that include security credentials. When the identity provider 512 can authenticate the security credentials in a request (e.g., via a validation function, cross-reference look-up, or some other authentication process), the identity provider 512 can communicate a security token in response to the request. A surveillance client 136 or a camera agent 138 can receive, store, and include the security token in subsequent ingress messages 516B, so that the transport service 126A is able to securely process (e.g., unpack/parse) the packages included in the ingress messages 516B to extract the location data prior to passing the location data to the surveillance service 128.

Continuing with the example of FIG. 5A, the transport services 126 are configured to receive the ingress messages 516B, verify the authenticity of the messages 516B, parse the messages 516B, and extract the location data encoded therein prior to passing the location data to the surveillance service 128 for processing. This location data can include any of the location data described above with reference to FIG. 1. Individual transport services 126 may be configured to process ingress messages 516B generated by location-based monitoring equipment of a particular manufacturer and/or model. The surveillance clients 136 and the camera agents 138 are configured to generate and communicate, to the surveillance service 128 via the network 118, ingress messages 516B that include packages of location data based on sensor information received at the locations 102.

Continuing with the example of FIG. 5A, the computing devices 518 are configured to host the monitor interfaces 130. In some examples, individual monitor interfaces 130A-130M are configured to render GUIs including one or more image frames and/or other sensor data. In certain examples, the customer device 122 is configured to host the customer interface 132. In some examples, customer interface 132 is configured to render GUIs including one or more image frames and/or other sensor data. Additional features of the monitor interfaces 130 and the customer interface 132 are described further below with reference to FIG. 6.

Turning now to FIG. 5B, selected aspects of the system 100 of FIG. 1 that support implementation of profiles are schematically illustrated. As shown in FIG. 5B, these aspects include the data center environment 124 of FIG. 1. The data center environment 124 illustrated in FIG. 5B includes the features of the data center environment 124 illustrated in FIG. 5A. FIG. 5B illustrates other features not expressly enumerated in FIG. 5A, namely a profile data store 550 within the surveillance service 128. The profile data store 550 is configured to persistently store configuration data that specifies attributes of profiles. In some implementations, individual records of profile data are stored under a schema that includes fields sized and typed to store a variety of data values. For instance, in some examples, profile records 552 stored in the data store 550 include a field (e.g., a Profile_ID field) configured to store an identifier of a profile. A profile record 552 may include any data structure with fields that specify attributes of a profile. The profile identifier field included within a profile record 552 may be a primary key that holds values that uniquely identify individual profile records stored in the data store 550. For instance, the value stored in the profile field may be a globally unique identifier (GUID). Further, in some examples, the profile records 552 include a field (e.g., a User_ID field) configured to store an identifier of a customer account. This user identifier field may be a foreign key that links profiles to customer accounts.

Continuing with the example of FIG. 5B, in some instances, the profile records 552 also include a field (e.g., a Locations field) configured to store a list of identifiers of one or more locations assigned to, or otherwise associated with, the profile. The locations listed in the Locations field are either available for visitation by the subject of the profile or unavailable for visitation by the subject, depending on the value stored in the Allowed field which is described below. In some examples, the Locations field is required. Requiring that the Locations field be populated with at least one value prevents existence of orphaned profiles (e.g., profiles not assigned to with or otherwise associated with a location). Prevention of orphaned profiles, in turn, prevents waste of compute and storage resources that would otherwise be utilized to maintain the orphaned profiles.

Continuing with the example of FIG. 5B, in some implementations, the profile records 552 also include a field (e.g., a Profile_Name field) configured to store a name of the profile (e.g., the subject's name). Further, in some examples, the profile records 552 include a field (e.g., a Category field) configured to store a value indicating sentiment toward the subject of the profile. Further, in some examples, the profile records 552 include a field (e.g., a Main_Photo field) configured to store an image of a subject's face to represent the subject of the profile. Such an image of a face of an individual may be referred to herein as a “face clip”. In certain examples, the profile records 552 include a field (e.g., an Allowed field) configured to store an indicator of whether a subject of the profile is allowed to visit the locations listed in the Locations field. For instance, in some examples, the allowed field is configured to store a Boolean value of true or false. In addition, in some examples, the profile records 552 include a field (e.g., a Faces field) configured to store (e.g., by value or by reference) face clips of the subject. The faces field is useful to train one or more parts of the AI service 508 (e.g., based on a version of OpenFace, DeepFace, Face++, FaceNet, or other generally available facial recognition package(s)) to identify individuals depicted within image data. In some examples, the data store 550 is configured to store the face clips as actual image files (PNG, JPEG, etc.). Additionally or alternatively, in some examples, the data store 550 is configured to store feature sets (e.g., landmark points) representative of the face clips.

Turning now to FIG. 6, a monitoring process 600 is illustrated as a sequence diagram. The process 600 can be executed, in some examples, by a security system (e.g., the security system 100 of FIG. 1). More specifically, in some examples, at least a portion of the process 600 is executed by the location-based devices under the control of device control system (DCS) code (e.g., either the code 308 or 408) implemented by at least one processor (e.g., either of the processors 300 or 400 of FIGS. 3-4C). The DCS code can include, for example, a camera agent (e.g., the camera agent 138 of FIG. 1). At least a portion of the process 600 is executed by a base station (e.g., the base station 114 of FIG. 1) under control of a surveillance client (e.g., the surveillance client 136 of FIG. 1). At least a portion of the process 600 is executed by a monitoring center environment (e.g., the monitoring center environment 120 of FIG. 1) under control of a monitor interface (e.g., the monitor interface 130 of FIG. 1). At least a portion of the process 600 is executed by a data center environment (e.g., the data center environment 124 of FIG. 1) under control of a surveillance service (e.g., the surveillance service 128 of FIG. 1) or under control of transport services (e.g., the transport services 126 of FIG. 1). At least a portion of the process 600 is executed by a customer device (e.g., the customer device 122 of FIG. 1) under control of a customer interface (e.g., customer interface 132 of FIG. 1).

As shown in FIG. 6, the process 600 starts with the surveillance client 136 authenticating with an identity provider (e.g., the identity provider 512 of FIG. 5A) by exchanging one or more authentication requests and responses 604 with the transport service 126. More specifically, in some examples, the surveillance client 136 communicates an authentication request to the transport service 126 via one or more API calls to the transport service 126. In these examples, the transport service 126 parses the authentication request to extract security credentials therefrom and passes the security credentials to the identity provider for authentication. In some examples, if the identity provider authenticates the security credentials, the identity provider generates a security token and transmits the security token to the transport service 126. The transport service 126, in turn, receives a security token and communicates the security token as a payload within an authentication response to the authentication request. In these examples, if the identity provider is unable to authenticate the security credentials, the transport service 126 generates an error code and communicates the error code as the payload within the authentication response to the authentication request. Upon receipt of the authentication response, the surveillance client 136 parses the authentication response to extract the payload. If the payload includes the error code, the surveillance client 136 can retry authentication and/or interoperate with a user interface of its host device (e.g., the user interface 212 of the base station 114 of FIG. 2) to render output indicating the authentication failure. If the payload includes the security token, the surveillance client 136 stores the security token for subsequent use in communication of location data via ingress messages. It should be noted that the security token can have a limited lifespan (e.g., 1 hour, 1 day, 1 week, 1 month, etc.) after which the surveillance client 136 may be required to reauthenticate with the transport services 126.

Continuing with the process 600, one or more DCSs 602 hosted by one or more location-based devices acquire 606 sensor data descriptive of a location (e.g., the location 102A of FIG. 1). The sensor data acquired can be any of a variety of types, as discussed above with reference to FIGS. 1-4C. In some examples, one or more of the DCSs 602 acquire sensor data continuously. In some examples, one or more of the DCSs 602 acquire sensor data in response to an event, such as expiration of a local timer (a push event) or receipt of an acquisition polling signal communicated by the surveillance client 136 (a poll event). In certain examples, one or more of the DCSs 602 stream sensor data to the surveillance client 136 with minimal processing beyond acquisition and digitization. In these examples, the sensor data may constitute a sequence of vectors with individual vector members including a sensor reading and a timestamp. Alternatively or additionally, in some examples, one or more of the DCSs 602 execute additional processing of sensor data, such as generation of one or more summaries of multiple sensor readings. Further still, in some examples, one or more of the DCSs 602 execute sophisticated processing of sensor data. For instance, if the security sensor includes an image capture device, the security sensor may execute image processing routines such as edge detection, motion detection, facial recognition, threat assessment, and reportable event generation.

Continuing with the process 600, the DCSs 602 communicate the sensor data 608 to the surveillance client 136. As with sensor data acquisition, the DCSs 602 can communicate the sensor data 608 continuously or in response to an event, such as a push event (originating with the DCSs 602) or a poll event (originating with the surveillance client 136).

Continuing with the process 600, the surveillance client 136 monitors 610 the location by processing the received sensor data 608. For instance, in some examples, the surveillance client 136 executes one or more image processing routines. These image processing routines may include any of the image processing routines described above with reference to the operation 606. By distributing at least some of the image processing routines between the DCSs 602 and surveillance clients 136, some examples decrease power consumed by battery-powered devices by off-loading processing to line-powered devices. Moreover, in some examples, the surveillance client 136 may execute an ensemble threat detection process that utilizes sensor data 608 from multiple, distinct DCSs 602 as input. For instance, in at least one example, the surveillance client 136 will attempt to corroborate an open state received from a contact sensor with motion and facial recognition processing of an image of a scene including a window to which the contact sensor is affixed. If two or more of the three processes indicate the presence of an intruder, the threat score is increased and or a break-in event is declared, locally recorded, and communicated. Other processing that the surveillance client 136 may execute includes outputting local alarms (e.g., in response to detection of particular events and/or satisfaction of other criteria) and detection of maintenance conditions for location-based devices, such as a need to change or recharge low batteries and/or replace/maintain the devices that host the DCSs 602. Any of the processes described above within the operation 610 may result in the creation of location data that specifies the results of the processes.

Continuing with the process 600, the surveillance client 136 communicates the location data 614 to the surveillance service 128 via one or more ingress messages 612 to the transport services 126. As with sensor data 608 communication, the surveillance client 136 can communicate the location data 614 continuously or in response to an event, such as a push event (originating with the surveillance client 136) or a poll event (originating with the surveillance service 128).

Continuing with the process 600, the surveillance service 128 processes 616 received location data. For instance, in some examples, the surveillance service 128 executes one or more routines described above with reference to the operations 606 and/or 610. Additionally or alternatively, in some examples, the surveillance service 128 calculates a threat score or further refines an existing threat score using historical information associated with the location identified in the location data and/or other locations geographically proximal to the location (e.g., within the same zone improvement plan (ZIP) code). For instance, in some examples, if multiple break-ins have been recorded for the location and/or other locations within the same ZIP code within a configurable time span including the current time, the surveillance service 128 may increase a threat score calculated by a DCS 602 and/or the surveillance client 136. In some examples, the surveillance service 128 determines, by applying a set of rules and criteria to the location data 614, whether the location data 614 includes any reportable events and, if so, communicates an event report 618A and/or 618B to the monitor interface 130 and/or the customer interface 132. A reportable event may be an event of a certain type (e.g., break-in) or an event of a certain type that satisfies additional criteria. For example, movement within a particular zone combined with a threat score that exceeds a threshold value may be a reportable event, while movement within the particular zone combined with a threat score that does not exceed a threshold value may be a non-reportable event. The event reports 618A and/or 618B may have a priority based on the same criteria used to determine whether the event reported therein is reportable or may have a priority based on a different set of criteria or rules.

Continuing with the process 600, the monitor interface 130 interacts 620 with monitoring personnel through, for example, one or more GUIs. These GUIs may provide details and context regarding one or more reportable events.

Continuing with the process 600, the customer interface 132 interacts 622 with at least one customer through, for example, one or more GUIs. These GUIs may provide details and context regarding one or more reportable events.

It should be noted that the processing of sensor data and/or location data, as described above with reference to the operations 606, 610, and 616, may be executed by processors disposed within various parts of the system 100. For instance, in some examples, the DCSs 602 execute minimal processing of the sensor data (e.g., acquisition and streaming only) and the remainder of the processing described above is executed by the surveillance client 136 and/or the surveillance service 128. This approach may be helpful to prolong battery runtime of location-based devices. In other examples, the DCSs 602 execute as much of the sensor data processing as possible, leaving the surveillance client 136 and the surveillance service 128 to execute only processes that require sensor data that spans location-based devices and/or locations. This approach may be helpful to increase scalability of the system 100 with regard to adding new locations.

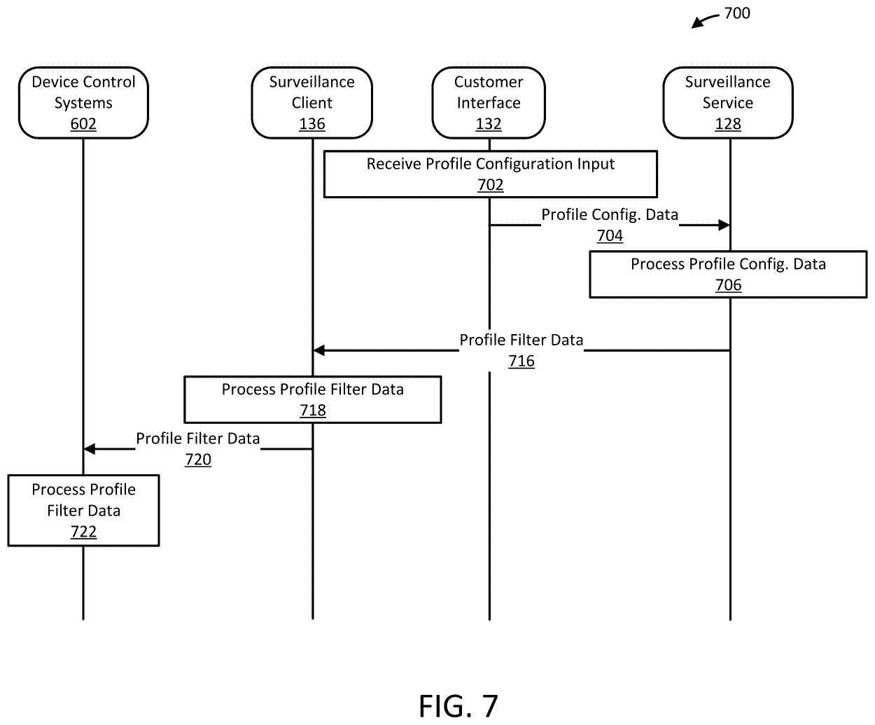

Turning now to FIG. 7, a process 700 to configure profiles is illustrated as a sequence diagram. The process 700 can be executed, in some examples, by a system (e.g., the security system 100 of FIG. 1). More specifically, in some examples, at least a portion of the process 700 is executed by the location-based devices under the control of device control system (DCS) code (e.g., the code 208, 308, or 408) implemented by at least one processor (e.g., the processors 200, 300, or 400 of FIGS. 2-4C). The DCS code can include, for example, a camera agent (e.g., the camera agent 138 of FIG. 1). At least a portion of the process 700 may be executed by a base station (e.g., the base station 114 of FIG. 1) under control of a surveillance client (e.g., the surveillance client 136 of FIG. 1). At least a portion of the process 700 may be executed by a data center environment (e.g., the data center environment 124 of FIG. 1) under control of a surveillance service (e.g., the surveillance service 128 of FIG. 1) or under control of transport services (e.g., the transport services 126 of FIG. 1) (not shown in FIG. 7). At least a portion of the process 700 may be executed by a customer, user, or edge device (e.g., the customer device 122 of FIG. 1) under control of a customer, user, or edge interface (e.g., customer interface 132 of FIG. 1).

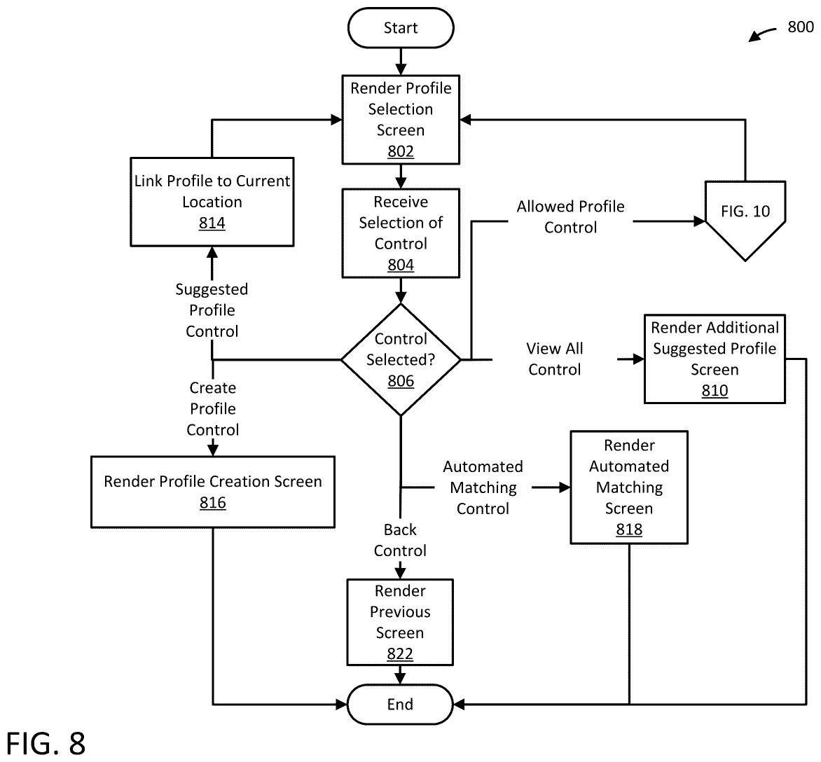

As shown in FIG. 7, the process 700 starts with the customer interface 132 receiving 702 input specifying profile configuration information. This profile configuration information may include a name of a new profile, one or more face clips of a subject of the new profile, and an identifier of at least one monitored location to link to, or otherwise associate with, the new profile. Alternatively or additionally, the profile configuration information may include a selection of an existing profile and an identifier of one or more monitored locations to link to the existing profile. In some examples, the customer interface 132 interacts with a user (e.g., a customer) via user interface screens rendered and administered by the customer interface 132 to obtain the profile configuration information. FIGS. 8-15, which are described further below, illustrate examples of screens and administrative processes that can be administered and executed by the customer interface 132 during the operation 702. It should be noted that, in some examples, profiles are required to be linked to, or otherwise be associated with, at least one location. In certain implementations the administrative processes executed by the customer interface 132 enforce this required linkage. For instance, as described further below, the customer interface 132 may infer the identifier of a monitored location to link with a profile from context previously established within the user interface. Alternatively or additionally, in some examples, the linkage requirement is enforced by other layers of the system, such as within the data model underlying the system and/or via one or more stored procedures triggered within a database that houses profile data (e.g., the profile data store 550). Other processes useful to enforce the requirement that profiles be linked to, or otherwise be associated with, at least one location will be apparent in view of this disclosure.

Continuing with the process 700, the customer interface 132 communicates profile configuration information 704 to the surveillance service 128. For instance, in some examples, the customer interface 132 transmits one or more ingress messages addressed to the surveillance service 128 that specify information (e.g., the profile configuration information 704). Transmission of these ingress messages may be accomplished via one or more API calls to transport services (e.g., the transport services 126 of FIG. 1), although this is not a requirement. For instance, the surveillance service 128 may expose and implement other APIs for purposes of transmission and/or receipt of profile configuration information.

Continuing with the process 700, the surveillance service 128 processes 706 information (e.g., profile configuration information) via one or more pipelines to validate, transform, and/or store the data (e.g., within the data store 550 of FIG. 5B). The processing executed within the operation 706 may include training an AI service (e.g., the AI service 508 of FIG. 5A) to recognize the subject of the profile using the one or more face clips specified in the profile configuration information and stored in the Locations field of a profile record 552 memorializing the profile. The specific processing executed within the operation 706 may depend on a variety of factors including, for example, a type of interface that generated the profile configuration information, an identity of an authenticated user of the interface, and/or other metadata descriptive of the profile included in the configuration information.

In certain examples, within the operation 706 the surveillance service 128 prepares data (e.g., profile filter data) based on the information about profile configurations stored in the data store 550. This profile filter data can be used by other processes of the system (e.g., the surveillance client 136 and/or the device control systems 602) to construct filters that prevent alarms from being triggered by a subject of the profile being detected at a location. For instance, in some examples, the surveillance service 128 extracts face clips (e.g., video/audio data) or features based thereon from the data store 550 and stores the extracted information in the profile filter data. Alternatively or additionally, in some examples, the surveillance service 128 trains an AI model using image data including the face images and stores model parameters (e.g., node weights, etc.) resulting from the training within the profile filter data. In some examples, the profile filter data can be distributed to base stations (e.g., the base station 114 of FIG. 1) and/or image capture devices (e.g., the image capture device 110 of FIG. 1) to enable these devices to recognize profiled subjects and take preconfigured actions (e.g., abort/not trigger an alarm) if a subject is detected at a monitored location that the subject is permitted to access. This distributed approach to recognizing subjects can reduce power consumption of, and network traffic within, the security system by distributing facial recognition processing to monitored locations.

Continuing with the process 700, the surveillance service 128 communicates profile filter data 716 to the surveillance client 136. For instance, in some examples, the surveillance service 128 transmits one or more egress messages addressed to the surveillance client 136 that specify the profile filter data 716 to the transport services. Transmission of the egress messages that specify the profile filter data 716 may be accomplished via the transport services.

Continuing with the process 700, the surveillance client 136 receives and processes 718 the profile filter data via one or more pipelines to validate, transform, and/or store the data (e.g., within the data store 210 of FIG. 2). The processing executed within the operation 718 may include training an AI process local to the base station (e.g., stored in the code 208 of FIG. 2) to recognize the subject of the profile using the one or more face images included in the profile filter data. Alternatively or additionally, the processing executed within the operation 718 may include adapting the local AI process to use model parameters stored in the profile filter data 716. Regardless, as a result of the operation 718, the base station is configured to allow the subject of the profile to access the location monitored by the base station without triggering an alarm.

Continuing with the process 700, the surveillance client 136 communicates profile filter data 720 to the DCSs 602 of image capture devices at the location monitored by the surveillance client 136. For instance, in some examples, the surveillance client 136 transmits one or more messages addressed to the DCSs 602 that specify the profile filter data 720. Transmission of these messages may be accomplished via any of the LAN or PAN technologies described above with reference to FIG. 1.

Continuing with the process 700, the DCSs 602 process 722 the profile filter data via one or more pipelines to validate, transform, and/or store the data (e.g., within the data store 410 of FIGS. 4A-4C). The processing executed within the operation 722 may include training an AI process local to the image capture device (e.g., stored in the code 408 of FIGS. 4A-4C) to recognize the subject of the profile using the one or more face images included in the profile filter data. Alternatively or additionally, the processing executed within the operation 722 may include adapting the local AI process to use model parameters stored in the profile filter data 716. Regardless, as a result of the operation 722, the image capture devices are configured to allow allowed subjects to access the location monitored by the base station without triggering an alarm.

Turning now to FIG. 8, a process 800 of administering a profile selection screen is illustrated. The process 800 enables a system (e.g., a security system) to select and utilize profiles to gain the advantages of the same as described herein. It should be noted that, in some examples, prior to initiation of the process 800, a program (e.g., one of the customer interfaces 132 introduced in FIG. 1) controlling a computing device (e.g., one of the customer devices 122 of FIG. 1) has received user input selecting a location and maintains the location (as a current location) in context during execution of the process 800.

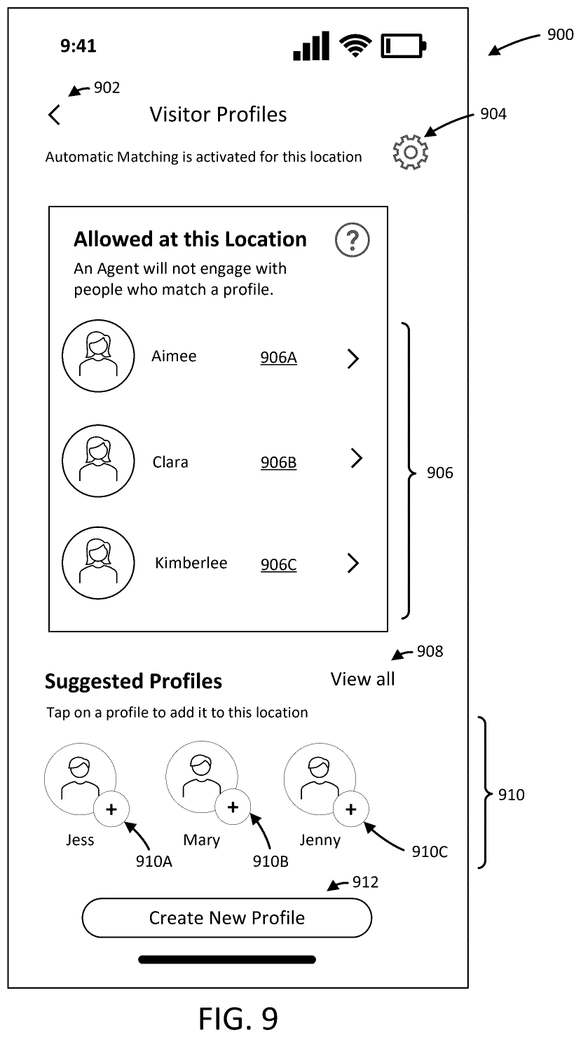

As shown in FIG. 8, the process 800 starts with the program controlling the computing device to render 802 a screen (e.g., a profile or “familiar faces” selection screen). In some examples, the program suggests one or more profiles (which may also be referred to as familiar faces, contacts, or other terminology) for assignment to the current location via the operation 802, as will be described further below. FIG. 9 illustrates one example of a profile selection screen 900 that can be rendered in some examples. As shown in FIG. 9, the profile selection screen 900 includes a back control 902, an automated match control 904, allowed profile control group 906, a view all control 908, a suggested profile control group 910, and a create profile control 912. The control group 906 includes allowed profile controls 906A-906C. The control group 910 includes suggested profile controls 910A-910C. Through the profile selection screen 900 and the controls included therein, the program enables the user to select profiles of subjects trusted to visit locations associated with a user account.

In some examples, individual controls 906A-906C and 910A-910C include face clips representative of the subjects of the profiles represented by the controls, as may be stored in a Main_Photo field of a profile record 552 as described above with reference to FIG. 5B. If no face clips are currently selected for a profile, the program may include a generic image within a profile control, as illustrated by the suggested profile control 910C. Further, as shown in FIG. 9, individual controls 906A-906C and 910A-910C include textual identifiers of the profiles represented by the controls, as may be stored in a Profile_Name field of a profile record 552 as described above with reference to FIG. 5B.

As shown in FIG. 9, the screen 900 is configured to receive selections from a user that link, or otherwise associate, profiles with a currently selected location. In some examples, the screen 900 continues a location-centric theme within a GUI rendered via execution of the program. For instance, in some examples, the GUI includes a screen rendered prior to the screen 900 that receives a user selection of a current location. The program maintains the current location in context within subsequently rendered screens. This feature enables the subsequent screens, such as the screen 900, to omit controls configured to select a location, thereby increasing the amount of screen space available for other controls, such as the control groups 906 and 910. Adherence to this location-centric theme provides additional benefits, such as increasing the case of learning and use of the GUI due to its consistent organization of features by location.

Continuing with examples illustrated by FIG. 9, the back control 902 is selectable by the user to navigate to the previously rendered screen in the GUI. The automated match control 904 is selectable to navigate to a screen with controls configured to receive data (e.g., configuration data) that specifies whether and how profiles are used to recognize individuals depicted in images acquired at the current location. The allowed profile controls 906A-906C are selectable to navigate to a screen with controls configured to modify data about profiles of subjects currently allowed to visit the location. This data may include any of the profile attributes described herein, such as the profile attributes introduced above with reference to FIG. 5B, as well as any metadata of a profile as described herein. As will be described further below, the suggested profile controls 910A-910C are selectable to link, or otherwise associate, a suggested profile represented by the selected control with the current location and to record the suggested profile as an allowed profile. The view all control 908 is selectable to navigate to a screen with additional, selectable suggested profile controls. The create profile control 912 is selectable to navigate to a screen with controls configured to receive configuration data for a new profile to link to the current location.

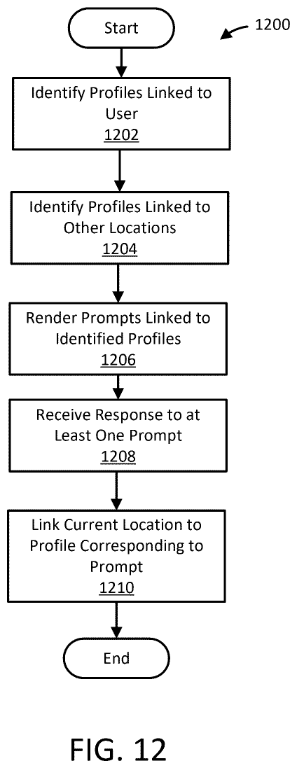

It should be appreciated that during execution of the operation 802, the program may execute a number of operations useful to suggest one or more profiles to a currently authenticated user for linking to the current location. For instance, in some examples of the operation 802, the program identifies, or otherwise determines, one or more profiles to suggest to the user by identifying, or otherwise determining, that the profiles are authorized to access other locations linked, or otherwise associated, with the user's account. Subjects of profiles that are trusted by the user to visit some locations may be trusted by the user to visit other locations. In some examples, the program may determine whether the subjects of the profiles are authorized to access another location by identifying whether the profiles are linked, or otherwise associated, with other locations. In at least one example, the program determines that a profile is linked, or otherwise associated, with another location by identifying that a record of the profile includes an identifier of the other location in the Locations field. Other operations the program may execute that are useful to suggest one or more profiles to the user include rendering controls associated with profiles that are linked to the user or a location of the user monitored by the system. In these examples, the program prompts the user to confirm that one or more subjects of profiles associated with the controls are authorized to access the current location by selecting one or more of the controls. These and other operations that the program may be configured to execute are described further below with reference to FIG. 12—specifically with regard to operations 1202-1206.

Returning to the process 800 of FIG. 8, the program receives 804 input selecting a control of the screen 900. For instance, in some examples, the program receives a message from an operating system or other code (e.g., a runtime engine of a development platform, a virtual machine, etc.) executing on the computing device. The message may include information regarding an interaction between the touchscreen, a mouse, or some other input device and a user. For instance, the message may specify a location, duration of interaction, and any movement detected on the touchscreen, via the mouse, etc. Alternatively or additionally, the message may specify an identifier of a control of the screen and a type of selection (e.g., a tap, a double tap, a double click, a swipe, a long press, a drag-and-drop, some other gesture, etc.).

Continuing with the process 800, the program determines 806 which control of the screen 900 is selected. For instance, in some examples, the program identifies the control and the type of selection based on a message received in the operation 804. In certain examples, the program makes this determination by identifying the location specified in the message as being within an area of the screen occupied by the control and by classifying the selection type using the duration and type of interaction(s) specified in the message. Alternatively or additionally, the program may make this determination by reading an identifier of the control and the type of selection from the message.

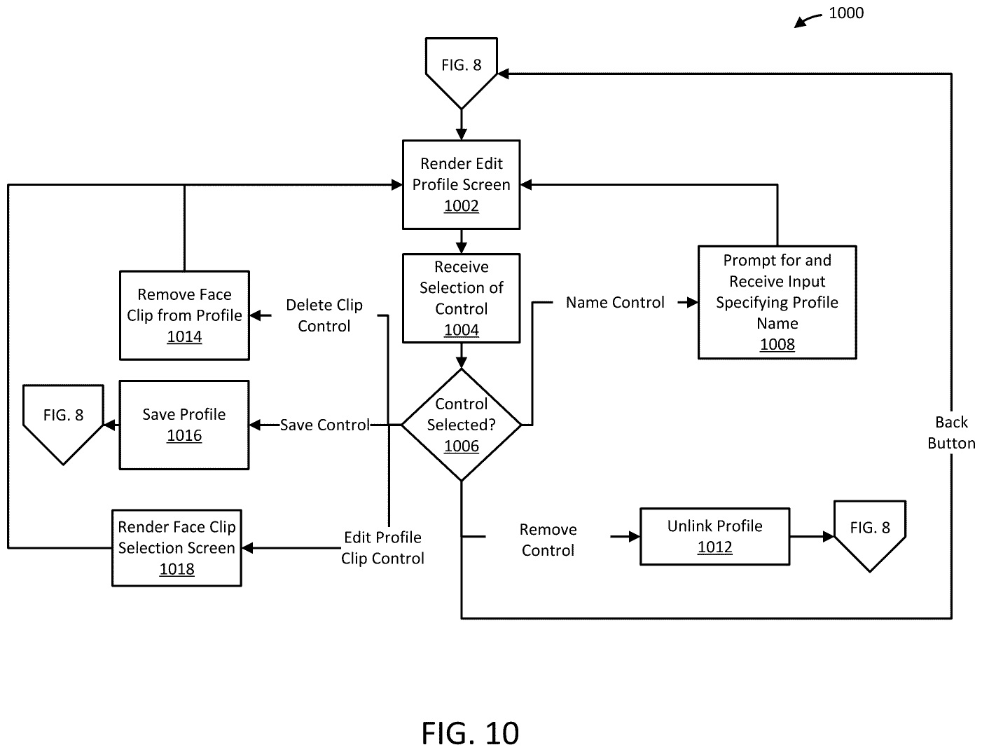

Continuing with the process 800, if the program determines that one of the allowed profile controls 906A-906C is selected, the program executes a profile editing process. FIG. 10 illustrates an example of such a process, profile editing process 1000. As shown in FIG. 10, the process 1000 starts with the program controlling the host computing device to render 1002 a screen (e.g., a profile editing screen) via a touchscreen. This screen may include controls configured to display, and receive and store edits to, configuration information stored in a profile record 552 associated with the selected control. For instance, in at least one example, the screen includes controls configured to display, and receive and store edits to, the Main_Photo field, the Profile_Name field, the Allowed field, and the Faces field of a profile record 552 as described above with reference to FIG. 5B. The screen to edit profiles may further include a control selectable to revoke the subject's access to a location by removing the profile from the current location and/or deleting the profile record 552. The screen may further include a control selectable to save changes to information (e.g., the profile configuration information) stored in the profile record 552. In these examples, the program stores, in response to selection of the save control, any edits received via the screen to edit profiles. For instance, the program may change the value of the Allowed field from true to false or remove the current location from the Locations field in response to an edit thereto.

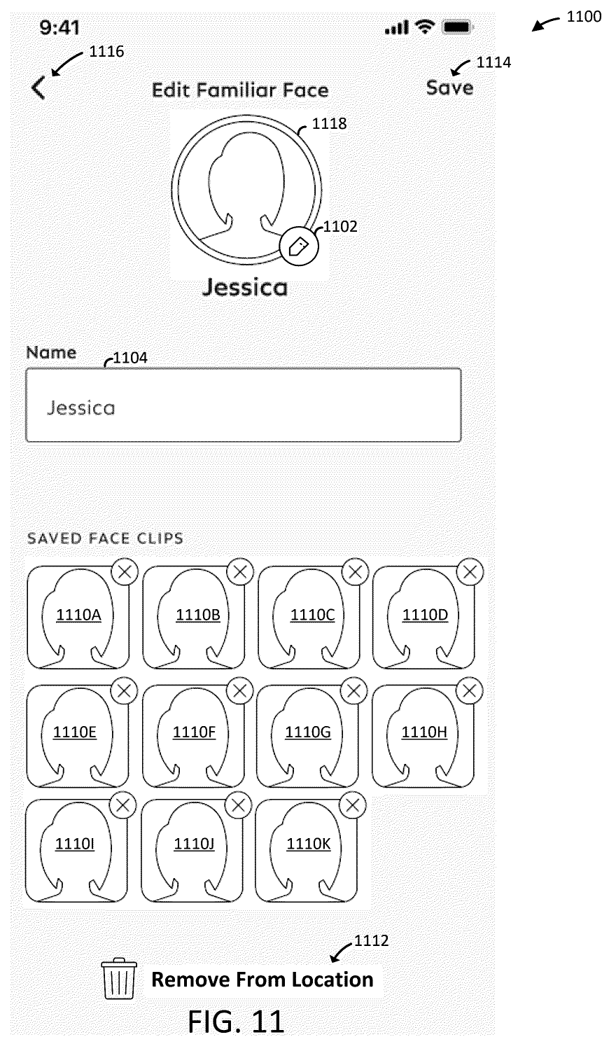

FIG. 11 illustrates one example of a screen to edit profiles (e.g., an edit profile screen 1100) that can be rendered in some examples. As shown in FIG. 11, the edit profile screen 1100 includes an edit profile clip button 1102, a profile name control 1104, delete clip controls 1110A-1110K, a remove profile control 1112, a save profile control 1114, a back control 1116, and a profile clip control 1118.

In some examples, the profile clip control 1118 includes a face clip representative of the subject of the profile being edited. If no face clips have been previously selected for the profile, the program may include a generic image within the profile clip control 1118. The name control 1104 can include a textual identifier of the profile (e.g., a subject's name). The delete clip controls 1110A-1110K include face clips that are currently linked, or otherwise associated, with the profile.

In some examples, the user can change a profile record 552 through the profile editing screen 1100 via the controls included therein. For instance, in certain examples, the edit profile clip button 1102 is selectable to change the face clip displayed in the profile clip control 1118 (e.g., as may be stored in a Main_Photo field). The name control 1104 is selectable to enter or edit a name for the profile (e.g., as may be stored in a Profile_Name field). The delete clip controls 1110A-1110k are selectable to disassociate, unassign, or unlink the face clip depicted within the control from the profile (e.g., by removing the depicted face clip from the Faces field). The remove profile control 1112 is selectable to disassociate, unassign, or unlink the profile from the location in context (e.g., by removing the location from the Locations field). As is described further below, disassociation of a profile from all locations may result in automatic deletion of the profile and profile record 552. Alternatively or additionally, in some examples, the profile editing screen 1100 can include a delete profile control (not shown in FIG. 11) that is selectable to disassociate, unassign, or unlink the profile from all locations. The save profile button 1114 is selectable to save changes made to the profile record 552. The back control 2116 is selectable to navigate to a screen present just prior to the screen 1100 (e.g., the screen 900 of FIG. 9).

Returning to the process 1000 of FIG. 10, the program receives 1004 input selecting a control of the screen 1100. For instance, in some examples, the program receives the input selecting the control by executing the processing described above with reference to the operation 804 of FIG. 8.

Continuing with the process 1000, the program determines 1006 which control of the screen 1100 is selected. For instance, in some examples, the program identifies the control and the type of selection by executing the processing described above with reference to the operation 806 of FIG. 8.

Continuing with the process 1000, if the program determines that the name control 1104 is selected, the program prompts for and receives 1008 input specifying a name for the profile. This name may be stored in the Profile_Name field of a profile record 552 being edited via the screen 1100. If the program determines that a delete clip control (e.g., one of delete clip controls 1110A-1110K) is selected, the program unlinks, or otherwise disassociates, 1014 the selected face clip depicted within the selected control from the profile. The operation 1014 may be accomplished by removing the selected face clip from the Faces field of the profile record 552. If the program determines that the save profile button 1114 is selected, the program saves 1016 any changes made to the profile via the screen 1100. If the program determines that the remove profile control 1112 is selected, the program unlinks, unassigns, or disassociates 1012 the location currently in context from the profile. This may be accomplished by removing the current location from the Locations field of the profile record 552. In some examples, if a profile is unlinked from all locations as a result of the operation 1012, the profile record 552 is deleted from the system (e.g., from the data store 550 introduced in FIG. 5B). It should be noted that the operations 1012 and 1016 may involve altering profile information locally and remotely, so that the security system as a whole can utilize the information. It should also be noted that some examples of the process 1000 may include a profile delete operation that deletes the profile record 552 associated with the profile, thereby unlinking the profile from all locations.

Continuing with the process 1000, if the program determines that the edit profile clip button 1102 is selected, the program renders 1018 another screen (e.g., a face clip selection screen). This screen may include, for example, controls configured to prompt for and receive selection of a face clip to be used to represent the profile. In response to receiving a selection of a representative face clip, the program may store the selected face clip in the Main_Photo field of the profile record 552.

Returning to the process 800 of FIG. 8, if the program determines that the back control button 928 is selected, the program closes 822 the screen 900 and returns to the previously rendered screen in the GUI. If the program determines that one of the suggested profile controls 910A-910C is selected, the program confirms that the subject of the selected profile is allowed to authorize the current location. For example, the program may link 814 or otherwise associate the current location with the profile linked with the selected control. This linkage or association may be accomplished by changing a profile record 552 associated with the selected control. For instance, in some examples, the program changes the value of the Allowed field in the profile record 552 from false to true and adds an identifier of the current location to the Locations field. These and other operations that the program may be configured to execute are described further below with reference to FIG. 12—specifically with regard to operations 1208-1210.

If the program determines that the view all control 908 is selected, the program renders 810 a screen (e.g., a suggested profile screen) with controls configured to receive selections of other suggested profiles. For instance, in at least one example, the screen includes the suggested profile controls 910A-910C and additional suggested profile controls. In another example, the screen includes suggested profile controls other than those included in the screen 900.

Continuing with the process 800, if the program determines that the automated match control 904 is selected, the program renders 818 another screen (e.g., an automated match screen) with controls configured to display, and receive and store edits to, configuration data that specifies whether and how profiles are used to recognize individuals depicted in images acquired at the current location. For instance, in some examples, the screen includes a match control to toggle on or off automated match for the current location. In these examples, the program stores, in response to selection of the match control, the current state (e.g., on or off) of the control. A change in the state of the match control may be propagated (via one or more messages) to the remainder of the system, thereby enabling or disabling use of profiles to recognize visitors to the current location.

Continuing with the process 800, if the program determines that the profile creation button 912 is selected, the program renders 816 yet another screen (e.g., a new profile screen) with controls configured to display, and receive and store edits to, configuration data to be stored in a new profile record 552. For instance, in at least one example, the screen includes controls configured to display, and receive and store edits to, the Main_Photo field, the Profile_Name field, the Allowed field, and the Faces field of a profile record 552 as described above with reference to FIG. 5B. The screen may further include a control selectable to save the new configuration information in a profile record 552. In these examples, the program stores, in response to selection of the save control, the new configuration information received via the new profile screen. Moreover, the program may store the current location within the Locations field without requiring express selection of the current location via a control (i.e., the current location may be implied by context).

Turning now to FIG. 12, a profile suggestion and acceptance process 1200 is illustrated. The process 1200 can be executed, in some examples, by a system (e.g., the security system 100 of FIG. 1). More specifically, in some examples, at least a portion of the process 1200 is executed by a data center environment (e.g., the data center environment 124 of FIG. 1) under control of a surveillance service (e.g., the surveillance service 128 of FIG. 1) or under control of transport services (e.g., the transport services 126 of FIG. 1). In addition, at least a portion of the process 1300 is executed by a customer device (e.g., the customer device 122 of FIG. 1) under control of a customer interface (e.g., customer interface 132 of FIG. 1).

As shown in FIG. 12, the process 1200 starts with a computing device (e.g., the customer device) identifying 1202 profiles linked to a user. For instance, in some examples, a program (e.g., the customer interface) controls the computing device to query a profile data store (e.g., the profile data store 550 introduced in FIG. 5B) for all Profile_ID's stored within records linked, or otherwise associated, with the currently authenticated user of the program. In at least one example, the program selects all Profile_IDs from profile records 552 in the data store where the User_ID stored in the profile record is equal to an identifier of the user's account.

Continuing with the process 1200, a device identifies 1204 which of the profiles identified by the operation 1202 are linked to locations other than the current location. For instance, in some examples, the program filters profile records 552 that include an identifier of the current location in the Locations field from the profiles identified in the operation 1202. Additionally, the program may filter the profile records 552 that do not include a value of true in the Allowed field, in some examples. It should be noted that the operations 1202 and 1204 may be combined into a single operation in which the program selects all Profile_IDs from profile records 552 in the data store where the User_ID stored in the profile record is equal to an identifier of the user's account and the Locations field does not store an identifier of the current location. Other techniques for identifying profiles linked to locations other than the current location will be apparent in view of the present disclosure. It should also be noted that the operations 1202 and 1204 may involve querying a copy of the data store 550 local to the computing device and/or may involve communicating, via one or more API calls, with the data store 550 hosted in the data center environment 124 of FIG. 5B.

Continuing with the process 1200, a device renders 1206 prompts linked, or otherwise associated, with profiles identified in the operation 1204. For instance, in some examples, the program renders suggested profile controls (e.g., the controls 910A-910C of FIG. 9).

Continuing with the process 1200, a device receives 1208 a response to one or more prompts rendered in the operation 1206. For instance, in some examples, the program receives user input selecting one or more of the suggested profile controls rendered in the operation 1206.

Continuing with the process 1200, a device links, or otherwise associates, 1210 the current location to the profile linked with the profiles linked to the prompts responded to in the operation 1208. For instance, in some examples, the program stores an identifier of the current location in Locations field of the profile record 552 linked with the profile control rendered in the operation 1208. Additionally, the program may change, or otherwise store, a value of true in the Allowed field of the profile record 552. As with the operations 1202 and 1204, the operation 1210 may involve communicating, via one or more API calls, with the data store 550 hosted in the data center environment 124 of FIG. 5B.

It should be noted that devices other than a customer device can execute the operations of the process 1200 described above, depending on the implementation of the security system. For instance, in some examples, the operations 1202, 1204, and 1210 are executed by a data center environment (e.g., the data center environment 124 of FIG. 1). Each of these configurations can provide advantages, depending on the goals and constraints of the security system. For instance, a highly distributed approach in which the customer device executes most or all of the process 1200 benefits from greater scalability and faster responses to potential and actual threats. However, a highly distributed approach also requires customer devices with more computing power and greater power consumption than centralized approaches in which the datacenter environment executes most or all of the process 1200.

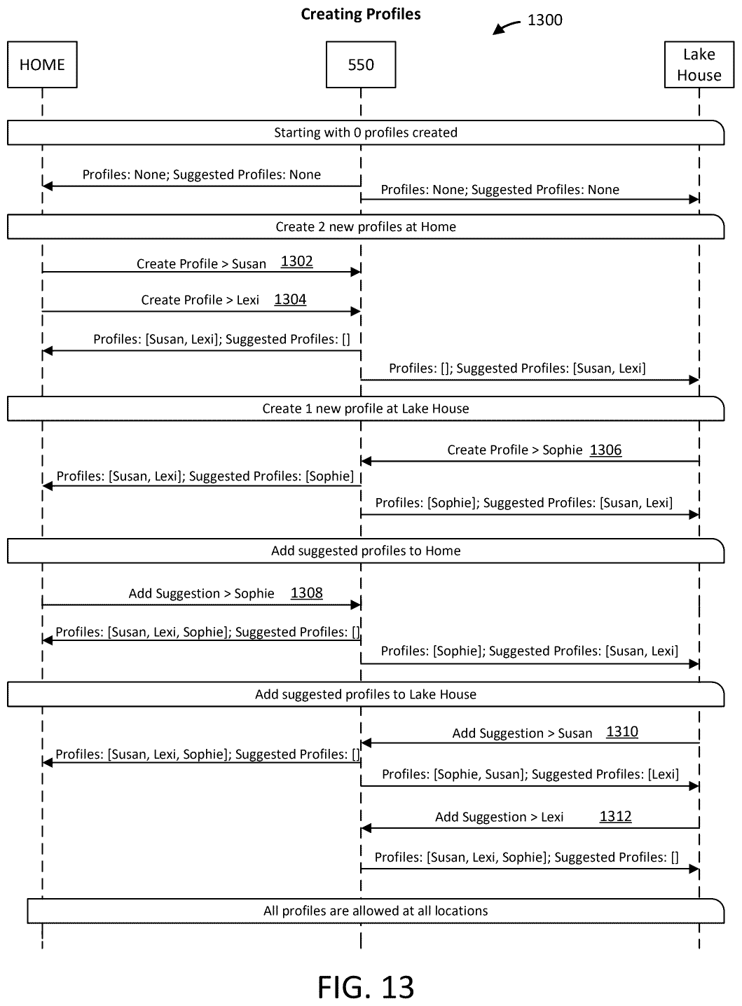

Turning now to FIG. 13, a profile creation and assignment process 1300 is illustrated. The process 1300 can be executed, in some examples, by a system (e.g., the security system 100 of FIG. 1). More specifically, in some examples, at least a portion of the process 1300 is executed by a data center environment (e.g., the data center environment 124 of FIG. 1) under control of a surveillance service (e.g., the surveillance service 128 of FIG. 1) or under control of transport services (e.g., the transport services 126 of FIG. 1). In addition, at least a portion of the process 1300 is executed by a customer device (e.g., the customer device 122 of FIG. 1) under control of a customer interface (e.g., customer interface 132 of FIG. 1).

As shown in FIG. 13, prior to initiation of the process 1300, the profile data store 550 has no profiles created for a user account associated with two monitored locations (e.g., named “Home” and “Lake House”). The process 1300 starts with creation 1302 and 1304 of two profiles (e.g., one named “Susan” and another named “Lexi”) within the context of, and therefore linked to or otherwise associated with, the Home location. For instance, in some examples, a computing device (e.g., one of the customer devices 122 of FIG. 1) receives user input requesting creation of the two profiles via a new profile screen rendered within the context of the Home location, such as the new profile screen described above with reference to FIG. 8. This user input may specify the profile names of Susan and Lexi and, in response to reception of the user input, a program hosted by the computing device (e.g., one of the customer interfaces 132 of FIG. 1) may communicate an API call to a transport service (e.g., one of the transport services 126 of FIG. 1). The API call may specify a request to store two new profile records 552 in the data store 550. The request may specify values of “Susan” and “Lexi” for the Profile_Name fields and a value of “Home” for the Locations field. In response to reception of the API call, the transport service may parse arguments of the call, extract the field values specified therein, and store the extracted values in two new profile records 552 within the data store 550. It should be noted that, after completion of the operations 1302 and 1304, the program would include allowed profile controls for Susan and Lexi in a profile selection screen (e.g., the profile selection screen 900 of FIG. 9) rendered within the context of the Home location. Additionally, the program would include suggested profile controls for Susan and Lexi in a profile selection screen rendered within the context of the Lake House location.

Continuing with the process 1300, the program creates 1306 another profile (e.g., one named “Sophie”), within the context of, and therefore linked to, the Lake House location. For instance, in some examples, the computing device receives user input requesting creation of the profile via a new profile screen rendered within the context of the Lake House location. This user input may specify the profile name of Sophie and, in response to reception of the user input, the program hosted by the computing device may communicate an API call to the transport service. The API call may specify a request to store a new profile record 552 in the data store 550. The request may specify a value of “Sophie” for the Profile_Name field and a value of “Lake House” for the Locations field. In response to reception of the API call, the transport service may parse arguments of the call, extract the field values specified therein, and store the extracted values in a new profile record 552 within the data store 550. It should be noted that, after completion of the operation 1306, the program would include an allowed profile control for Sophie in a profile selection screen rendered within the context of the Lake House location. Additionally, the program would include a suggested profile control for Sophie in a profile selection screen rendered within the context of the Home location.

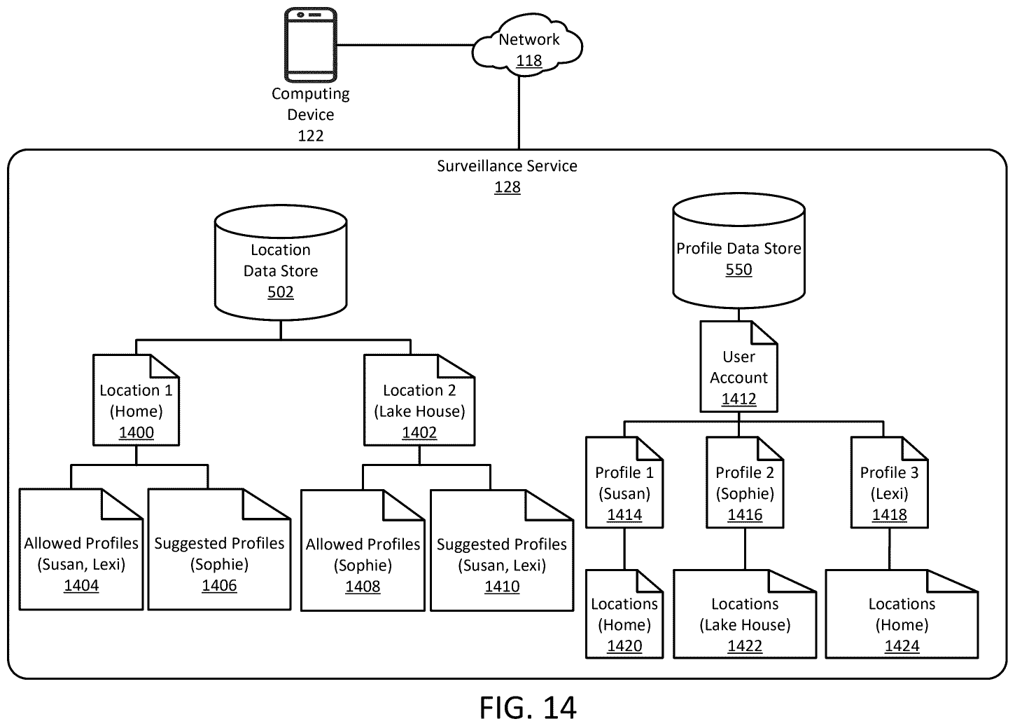

Turning now to FIG. 14, a schematic illustration of portions of profile and location data resulting from execution of operations 1302-1306 is visualized. As shown, FIG. 14 illustrates one of the computing devices 122, the network 118, and the surveillance service 128 of FIG. 1. FIG. 14 further includes the data stores 502 and 550 introduced in FIGS. 5A and 5B.

As depicted in FIG. 14, the profile data store 550 houses three profile records 1414-1418 (e.g., examples of the profile record 552 illustrated in FIG. 5B) that are linked, or otherwise associated with, an account 1412 of a user. For instance, individual profile records 1414-1418 may store an identifier of the account 1412 within a User_ID field. The profile record 1414 may be further linked, or otherwise associated with, a Home location 1400 recorded in the location data store 502. For instance, the profile record 1414 may store an identifier of the Home location 1400 within a Locations field 1420. The profile record 1416 may be further linked, or otherwise associated with, a Lake House location 1402 recorded in the location data store 502. For instance, the profile record 1416 may store an identifier of the Lake House location 1402 within a Locations field 1422. The profile record 1418 may be further linked, or otherwise associated with, the Home location 1400. For instance, the profile record 1418 may store an identifier of the Home location 1400 within a Locations field 1424. It should be noted that any of the Locations fields 1420-1424 may include multiple location identifiers and that inclusion of location identifiers within a Locations field indicates that the subject of the profile record may visit the identified locations without the security system raising an alarm.

Continuing examples illustrated by FIG. 14, the data store 502 houses the two location records 1400 and 1402 that are linked, or otherwise associated with, the profile records 1414-1418. More specifically, as illustrated in FIG. 14, the Home location record 1400 is linked with allowed profiles (Susan and Lexi) via data stored in a field 1404 and linked with suggested profiles (Sophic) via data stored in another field 1406. Similarly, the Lake House location record 1402 is linked with allowed profiles (Sophic) via data stored in a field 1408 and linked with suggested profiles (Susan, Lexi) via data stored in another field 1410. As will be appreciated in view of this disclosure, the linkages or associations described herein may be established by storing the linked items (by value or by reference) in a common data structure, storing a pointer or other reference to a linked item within the other linked item, and/or storing the linked items at addresses in memory related to one another by a function. Other methods of linking or associating data will be apparent in view of this disclosure. Moreover, the classification of profiles into a set of allowed profiles for a location and a set of suggested profiles for the location may be completed and stored (e.g., in the fields 1404-1410) in response to reception of profile configuration data or on-the-fly by a program (e.g., one of the customer interfaces 132 and/or the surveillance service 128 of FIG. 1) as part of rendering a profile selection screen such as the screen 900 of FIG. 9. Where classification of profiles into allowed and suggested groups is done by a customer interface, fields memorializing the classification may be allocated and populated in memory local to the computing device 122. In these instances, fields such as the fields 1404-1410 may be maintained only on the computing device 122 and not by the surveillance service 128, thereby increasing system scalability. Other classification determination and storage approaches will be apparent.

Returning to the process 1300 of FIG. 13, the program adds 1308 a suggested profile (e.g., Sophie) to the Home location. For instance, in some examples, the computing device receives user input selecting a suggested profile control linked to, or otherwise associated with, the Sophic profile and included within a profile selection screen rendered in the Home location context. In response to reception of the user input, the program hosted by the computing device may communicate an API call to the transport service. The API call may specify a request to add a value of “Home” to the Locations field of a profile record 552 defining attributes of the Sophic profile. In response to reception of the API call, the transport service may parse arguments of the call, extract the field value specified therein, and store the extracted value in the profile record within the data store 550 that defines attributes of the Sophie profile. It should be noted that, after completion of the operation 1308, the program would include a suggested profile control for Sophie in a profile selection screen rendered within the context of the Lake House location. Additionally, the program would include no suggested profile controls in a profile selection screen rendered within the context of the Home location because all profiles associated with the user (i.e., Susan, Lexi, and Sophie) are linked to the Home location.

Continuing with the process 1300, the program adds 1310 a suggested profile (e.g., Susan) to the Lake House location. For instance, in some examples, the computing device receives user input selecting a suggested profile control linked to, or otherwise associated with, the Susan profile and included within a profile selection screen rendered in the Lake House location context. In response to reception of the user input, the program hosted by the computing device may communicate an API call to the transport service. The API call may specify a request to add a value of “Lake House” to the Locations field of a profile record 552 defining attributes of the Susan profile. In response to reception of the API call, the transport service may parse arguments of the call, extract the field value specified therein, and store the extracted value in the profile record 552 within the data store 550 that defines attributes of the Sophie profile. It should be noted that, after completion of the operation 1310, the program would include an allowed profile control for Susan in a profile selection screen rendered within the context of the Lake House location.

Continuing with the process 1300, the program adds 1312 a suggested profile (e.g., Lexi) to the Lake House location. For instance, in some examples, the computing device receives user input selecting a suggested profile control linked to, or otherwise associated with, the Lexi profile and included within a profile selection screen rendered in the Lake House location context. In response to reception of the user input, the program hosted by the computing device may communicate an API call to the transport service. The API call may specify a request to add a value of “Lake House” to the Locations field of a profile record 552 defining attributes of the Lexi profile. In response to reception of the API call, the transport service may parse arguments of the call, extract the field value specified therein, and store the extracted value in the profile record 552 within the data store 550 that defines attributes of the Lexi profile. It should be noted that, after completion of the operation 1312, the program would include an allowed profile control for Lexi in a profile selection screen rendered within the context of the Lake House location. Additionally, the program would include no suggested profile controls in a profile selection screen rendered within the context of the Lake House location because all profiles associated with the user (i.e., Susan, Lexi, and Sophie) are linked to the Lake House location. Subsequent to the operation 1312 the process 1300 can end.

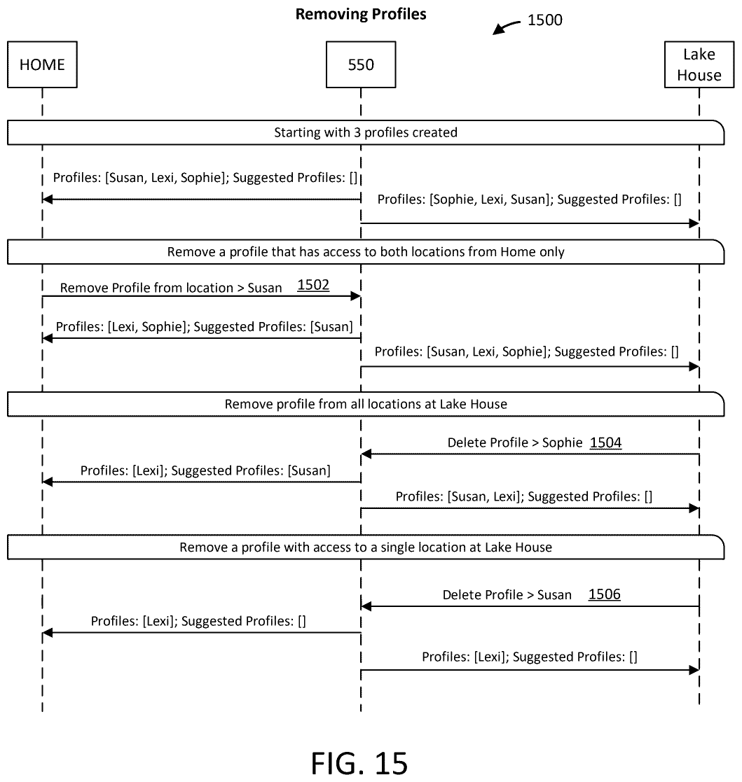

Turning now to FIG. 15, a profile removal and deletion process 1500 is illustrated. The process 1500 can be executed, in some examples, by a system (e.g., the security system 100 of FIG. 1). More specifically, in some examples, at least a portion of the process 1500 is executed by a data center environment (e.g., the data center environment 124 of FIG. 1) under control of a surveillance service (e.g., the surveillance service 128 of FIG. 1) or under control of transport services (e.g., the transport services 126 of FIG. 1). In addition, at least a portion of the process 1500 is executed by a customer device (e.g., the customer device 122 of FIG. 1) under control of a customer interface (e.g., customer interface 132 of FIG. 1).

As shown in FIG. 15, prior to initiation of the process 1500, the profile data store 550 has three profiles (e.g., named “Susan”, “Lexi”, and “Sophie”) assigned to two monitored locations (e.g., named “Home” and “Lake House”) linked to a user account. The process 1500 starts with removal 1502 of the Susan profile from the Home location. For instance, in some examples, a computing device (e.g., one of the customer devices 122 of FIG. 1) receives user input requesting removal of the profiles via a profile editing screen rendered within the context of the Home location, such as the profile editing screen described above with reference to FIG. 11. This user input may select a remove control and, in response to reception of the user input, a program hosted by the computing device (e.g., one of the customer interfaces 132 of FIG. 1) may communicate an API call to a transport service (e.g., one of the transport services 126 of FIG. 1). The API call may specify a request to unlink the Susan profile from the Home location. The request may specify a Profile_ID of the Susan profile and a value of “Home” for the Locations field. In response to reception of the API call, the transport service may parse arguments of the call, extract the field values specified therein, and remove the value of “Home” from the Locations field of the profile record 552 stored in the data store 550 that memorializes the Susan profile. It should be noted that, after completion of the operation 1502, the program would include allowed profile controls for Lexi and Sophie and a suggested profile control for Susan in a profile selection screen (e.g., the profile selection screen 900 of FIG. 9) rendered within the context of the Home location. Additionally, the program would include allowed profile controls for Susan, Lexi, and Sophie in a profile selection screen rendered within the context of the Lake House location.

Continuing with the process 1500, the program deletes 1504 the Sophie profile from the data store 550. For instance, in some examples, the computing device receives user input selecting a delete profile control, such as the delete profile control described above with reference to FIG. 11. In these examples, in response to reception of the selection of the delete profile control, the program hosted by the computing device communicates an API call to the transport service. The API call may specify a request to delete the Susan profile from the data store 550. The request may specify a value of a Profile_ID for the Sophie profile. In response to reception of the API call, the transport service may parse arguments of the call, extract the field values specified therein, and erase the profile record 552 in the data store 550 that memorializes the Susan profile. In another example, the computing device may receive first input selecting a remove profile control for the Sophic profile within the Home location context and second input selecting a remove profile control for the Sophie profile within the Lake House location context. In this example, the computing device unlinks the Home location from the Sophie profile in the same manner that the Susan profile was unlinked from the Home location in the operation 1502. Similarly, in this example, the computing device also unlinks the Lake House location from the Sophie profile, but the computing device further deletes the profile record 552 from the data store 550 because, after being unlinked from the Lake House location, the Sophie profile is no longer linked to any profile. It should be noted that, after completion of the operation 1504, the program would include an allowed profile control for Lexi and a suggested profile control for Susan in a profile selection screen rendered within the context of the Home location. Additionally, the program would include allowed profile controls for Lexi and Sophie in a profile selection screen rendered within the context of the Lake House location.

Continuing with the process 1500, the program removes 1506 the Susan profile from the Lake House location and, as a result, deletes the Susan profile from the data store 550. For instance, in some examples, the computing device receives user input selecting a remove profile control within the context of the Lake House location. In these examples, in response to reception of the selection of the remove profile control, the program hosted by the computing device communicates an API call to the transport service. The API call may specify a request to remove the Susan profile from the Lake House location. The request may specify a Profile_ID for the Susan profile and a value of “Lake House” for the Locations field. In response to reception of the API call, the transport service may parse arguments of the call, extract the field values specified therein, and remove the value of “Lake House” from the Locations field of the profile record 552 stored in the data store 550 that memorializes the Susan profile. Further, in this example, the computing device also erases the profile record 552 from the data store 550 because, after being unlinked from the Lake House location, the Susan profile is no longer linked to any profile. It should be noted that, after completion of the operation 1506, the program would include an allowed profile control for Lexi in a profile selection screen rendered within the context of the Home location or within the context of the Lake House location.

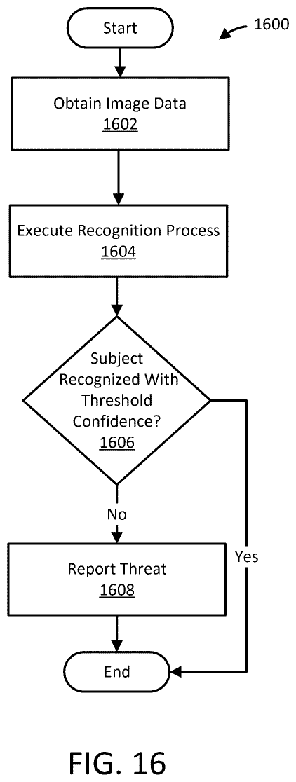

Turning now to FIG. 16, a threat detection process 1600 that utilizes profiles is illustrated. The process 1600 can be executed, in some examples, by a system (e.g., the security system 100 of FIG. 1). More specifically, in some examples, at least a portion of the process 1600 is executed by the location-based devices under the control of device control system (DCS) code (e.g., either the code 208, 308, or 408) implemented by at least one processor (e.g., either of the processors 200, 300, or 400 of FIGS. 2-4C). The DCS code can include, for example, a camera agent (e.g., the camera agent 138 of FIG. 1). Alternatively or additionally, a portion of the process 1600 can be executed by a base station (e.g., the base station 114 of FIG. 1) under control of a surveillance client (e.g., the surveillance client 136 of FIG. 1). Alternatively or additionally, at least a portion of the process 1600 can be executed by a data center environment (e.g., the data center environment 124 of FIG. 1) under control of a surveillance service (e.g., the surveillance service 128 of FIG. 1) or under control of transport services (e.g., the transport services 126 of FIG. 1).

As shown in FIG. 16, the process 1600 starts with a device obtaining 1602 image data that depicts a potential threat (e.g., a person) at a monitored location. For instance, in some examples, an image capture device (e.g., the image capture device 110 of FIG. 1) captures image data via a camera incorporated therein and stores the image data locally for subsequent processing.

Continuing with the process 1600, a device executes a facial recognition process. For instance, in some examples, the image capture device executes an AI process trained to recognize subjects of profiles. In certain examples, the AI process returns a metric that indicates a level of confidence that a subject depicted in the image data is the subject of a profile associated with the monitored location.

Continuing with the process 1600, a device determines 1606 whether the metric transgresses a threshold value (e.g., 75%, 85%, 95%, etc.). For instance, in some examples, the image capture device determines whether the metric is greater than a threshold value of 85%. If the device determines that the metric fails to transgress the threshold value, the device proceeds to operation 1608. If the device determines that the metric transgresses the threshold value, the process 1600 can refrain from initiating an alarm and end because the image likely depicts a subject of a profile.

Continuing with the process 1600, a device determines that the potential threat is an actual threat and communicates 1608 this reportable event to another device within the security system. For instance, in some examples, the image capture device communicates the actual threat to a base station (e.g., the base station 114 of FIG. 1), and the process 1600 can end.

It should be noted that devices other than an image capture device can execute the operations of the process 1600 described above, depending on the implementation of the system. For instance, in some examples, the operation 1602 can be executed by the base station or a data center environment (e.g., the data center environment 124 of FIG. 1). In these examples, either the base station or the data center environment can receive image data originally acquired by the image capture device. In some examples, the operations 1604, 1606, and 1608 can also be executed by the base station or a data center environment. Each of these configurations can provide advantages, depending on the goals and constraints of the security system. For instance, a highly distributed approach in which the image capture devices execute most or all of the process 1600 benefits from greater scalability and faster responses to potential and actual threats. However, a highly distributed approach also requires image capture devices with more computing power and greater power consumption than centralized approaches in which the base station and/or datacenter environment execute most or all of the process 1600.

Turning now to FIG. 17, a computing device 1700 is illustrated schematically. As shown in FIG. 17, the computing device includes at least one processor 1702, volatile memory 1704, one or more interfaces 1706, non-volatile memory 1708, and an interconnection mechanism 1714. The non-volatile memory 1708 includes code 1710 and at least one data store 1712.

In some examples, the non-volatile (non-transitory) memory 1708 includes one or more read-only memory (ROM) chips; one or more hard disk drives or other magnetic or optical storage media; one or more solid state drives (SSDs), such as a flash drive or other solid-state storage media; and/or one or more hybrid magnetic and SSDs. In certain examples, the code 1710 stored in the non-volatile memory can include an operating system and one or more applications or programs that are configured to execute under the operating system. Alternatively or additionally, the code 1710 can include specialized firmware and embedded software that is executable without dependence upon a commercially available operating system. Regardless, execution of the code 1710 can result in manipulated data that may be stored in the data store 1712 as one or more data structures. The data structures may have fields that are associated through colocation in the data structure. Such associations may likewise be achieved by allocating storage for the fields in locations within memory that convey an association between the fields. However, other mechanisms may be used to establish associations between information in fields of a data structure, including through the use of pointers, tags, or other mechanisms.

Continuing with the example of FIG. 17, the processor 1702 can be one or more programmable processors to execute one or more executable instructions, such as a computer program specified by the code 1710, to control the operations of the computing device 1700. As used herein, the term “processor” describes circuitry that executes a function, an operation, or a sequence of operations. The function, operation, or sequence of operations can be hard coded into the circuitry or soft coded by way of instructions held in a memory device (e.g., the volatile memory 1704) and executed by the circuitry. In some examples, the processor 1702 is a digital processor, but the processor 1702 can be analog, digital, or mixed. As such, the processor 1702 can execute the function, operation, or sequence of operations using digital values and/or using analog signals. In some examples, the processor 1702 can be embodied in one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), or multicore processors. Examples of the processor 1702 that are multicore can provide functionality for parallel, simultaneous execution of instructions or for parallel, simultaneous execution of one instruction on more than one piece of data.

Continuing with the example of FIG. 17, prior to execution of the code 1710 the processor 1702 can copy the code 1710 from the non-volatile memory 1708 to the volatile memory 1704. In some examples, the volatile memory 1704 includes one or more static or dynamic random access memory (RAM) chips and/or cache memory (e.g., memory disposed on a silicon die of the processor 1702). Volatile memory 1704 can offer a faster response time than a main memory, such as the non-volatile memory 1708.

Through execution of the code 1710, the processor 1702 can control operation of the interfaces 1706. The interfaces 1706 can include network interfaces. These network interfaces can include one or more physical interfaces (e.g., a radio, an ethernet port, a USB port, etc.) and a software stack including drivers and/or other code 1710 that is configured to communicate with the one or more physical interfaces to support one or more LAN, PAN, and/or WAN standard communication protocols. The communication protocols can include, for example, TCP and UDP among others. As such, the network interfaces enable the computing device 1700 to access and communicate with other computing devices via a computer network.

The interfaces 1706 can include user interfaces. For instance, in some examples, the user interfaces include user input and/or output devices (e.g., a keyboard, a mouse, a touchscreen, a display, a speaker, a camera, an accelerometer, a biometric scanner, an environmental sensor, etc.) and a software stack including drivers and/or other code 1710 that is configured to communicate with the user input and/or output devices. As such, the user interfaces enable the computing device 1700 to interact with users to receive input and/or render output. This rendered output can include, for instance, one or more GUIs including one or more controls configured to display output and/or receive input. The input can specify values to be stored in the data store 1712. The output can indicate values stored in the data store 1712.

Continuing with the example of FIG. 17, the various features of the computing device 1700 described above can communicate with one another via the interconnection mechanism 1714. In some examples, the interconnection mechanism 1714 includes a communications bus.

Various innovative concepts may be embodied as one or more methods, of which examples have been provided. The acts performed as part of a method may be ordered in any suitable way. Accordingly, examples may be constructed in which acts are performed in an order different than illustrated, which may include performing some acts simultaneously, even though shown as sequential acts in illustrative examples.

Descriptions of additional examples follow. Other variations will be apparent in light of this disclosure.

Example 1 is a method comprising suggesting, by a security system, that a subject of a profile be authorized to access a location; receiving, by the security system, confirmation that the subject is authorized to access the location; receiving, from an image capture device of a system, an image acquired at the location, the image depicting the subject; recognizing, by the security system, the subject in the image; and refraining, by the security system and based on the profile, from initiating an alarm in response to detecting the subject in the image.

Example 2 includes the method of example 1 wherein the location is a first location linked with an account of a user of the security system; and suggesting that the subject of the profile be authorized to access the first location comprises determining that the subject is authorized to access a second location linked with the account.

Example 3 includes the method of example 2, wherein determining that the subject is authorized to access the second location comprises determining that the second location is linked with the profile.

Example 4 includes the method of example 3, wherein determining that the second location is linked with the profile comprises locating an identifier of the second location within a record storing attributes of the profile.

Example 5 includes the method of example 4, wherein suggesting that the subject of the profile be authorized to access the first location further comprises rendering a control associated with the profile within a screen while the first location is in context.

Example 6 includes the method of example 5, wherein receiving the confirmation that the subject is authorized to access the first location comprises receiving input selecting the control.

Example 7 includes the method of example 6 and further includes linking, in response to receiving the confirmation, the first location with the profile.

Example 8 includes the method of example 7, wherein linking the first location with the profile comprises storing an identifier of the first location in the record.

Example 9 includes the method of any of examples 2 through 8 and further includes receiving a request to revoke authorization of the subject to access the second location; and unlinking, in response to receiving the request, the second location from the profile.

Example 10 includes the method of example 9, and further includes rendering a screen representative of the profile while the second location is in context, the screen including a control to revoke the authorization; and receiving the request comprises receiving input selecting the control.

Example 11 includes the method of either example 9 or example 10, wherein unlinking the second location from the profile comprises deleting the identifier of the second location from the record.

Example 12 includes the method of any of examples 9 through 11, wherein unlinking the second location from the profile comprises determining that the second location alone is linked with the profile; and deleting the record in response to determining that the second location alone is linked with the profile.

Example 13 is a system including a memory and at least one processor coupled with the memory and configured to suggest that a subject of a profile be authorized to access a location, receive confirmation that the subject is authorized to access the location, receive an image acquired at the location, the image depicting the subject, recognize the subject in the image; and refrain, based on the profile, from initiating an alarm in response to detecting the subject in the image.

Example 14 includes the system of example 13, wherein the location is a first location linked with an account of a user; and to suggest that the subject of the profile be authorized to access the first location comprises to determine that the subject is authorized to access a second location linked with the account.

Example 15 includes the system of example 14, wherein to determine that the subject is authorized to access the second location comprises to determine that the second location is linked with the profile.

Example 16 includes the system of example 15, wherein to determine that the second location is linked with the profile comprises to locate an identifier of the second location within a record storing attributes of the profile.

Example 17 includes the system of example 16, wherein to suggest that the subject of the profile be authorized to access the first location further comprises to render a control associated with the profile within a screen while the first location is in context.

Example 18 includes the system of example 17, wherein to receive the confirmation that the subject is authorized to access the first location comprises to receive input selecting the control.

Example 19 includes the system of example 18, wherein the at least one processor is further configured to link, in response to receiving the confirmation, the first location with the profile.

Example 20 includes the system of example 19, wherein to link the first location with the profile comprises to store the identifier of the first location in the record.

Example 21 includes the system of any of examples 14 through 20, wherein the at least one processor is further configured to: receive a request to revoke authorization of the subject to access the second location; and unlink, in response to reception of the request, the second location from the profile.

Example 22 includes the system of example 21, wherein the at least one processor is further configured to render a screen representative of the profile while the second location is in context, the screen including a control to revoke the authorization; and to receive the request comprises to receive input selecting the control.

Example 23 includes the system of either example 21 or example 22, wherein to unlink the second location from the profile comprises to delete an identifier of the second location from a record storing attributes of the profile.

Example 24 includes the system of any of examples 21 through 23, wherein to unlink the second location from the profile comprises to determine that the second location alone is linked with the profile; and delete a record of the profile in response to a determination that the second location alone is linked with the profile.

Example 25 is one or more non-transitory computer readable media storing sequences of instructions executable by at least one processor to filter events based on profiles, the sequences of instructions comprising instructions to suggest that a subject of a profile be authorized to access a location, receive confirmation that the subject is authorized to access the location, receive an image acquired at the location, the image depicting the subject, recognize the subject in the image; and refrain, based on the profile, from initiating an alarm in response to detecting the subject in the image.

Example 26 includes the one or more non-transitory computer readable media of example 25, wherein the location is a first location linked with an account of a user; and to suggest that the subject of the profile be authorized to access the first location comprises to determine that the subject is authorized to access a second location linked with the account.

Example 27 includes the one or more non-transitory computer readable media of example 26, wherein to determine that the subject is authorized to access the second location comprises to determine that the second location is linked with the profile.

Example 28 includes the one or more non-transitory computer readable media of example 27, wherein to determine that the second location is linked with the profile comprises to locate an identifier of the second location within a record storing attributes of the profile.

Example 29 includes the one or more non-transitory computer readable media of example 28, wherein to suggest that the subject of the profile be authorized to access the first location further comprises to render a control associated with the profile within a screen while the first location is in context.

Example 30 includes the one or more non-transitory computer readable media of example, wherein to receive the confirmation that the subject is authorized to access the first location comprises to receive input selecting the control.

Example 31 includes the one or more non-transitory computer readable media of example 30, wherein the sequences of instructions further comprise instructions to link, in response to receiving the confirmation, the first location with the profile.

Example 32 includes the one or more non-transitory computer readable media of example 31, wherein to link the first location with the profile comprises to store the identifier of the first location in the record.

Example 33 includes the one or more non-transitory computer readable media of any of examples 26 through 32, wherein the sequences of instructions further comprise instructions to receive a request to revoke authorization of the subject to access the second location; and unlink, in response to reception of the request, the second location from the profile.

Example 34 includes the one or more non-transitory computer readable media of example 33, wherein the sequences of instructions further comprise instructions to render a screen representative of the profile while the second location is in context, the screen including a control to revoke the authorization; and to receive the request comprises to receive input selecting the control.

Example 35 includes the one or more non-transitory computer readable media of either example 33 or example 34, wherein to unlink the second location from the profile comprises to delete the identifier of the second location from the record.

Example 36 includes the one or more non-transitory computer readable media of any of examples 33 through 35, wherein to unlink the second location from the profile comprises to determine that the second location alone is linked with the profile; and delete the record in response to a determination that the second location alone is linked with the profile.

Example 37 is a method including creating, by a computing device, a record representative of a person based on an image, the record including an identifier associated with a physical location; updating, by the computing device, the record to include the identifier within a data structure housing the record and thereby linking the person to the physical location; and providing, by the computing device, the updated record to one or more devices at the physical location, so as to enable a system present at the physical location to recognize the person at that location and take one or more actions.

Example 38 is a method including determining, by a computing system, that a profile of a person is no longer associated with a physical location; determining, by the computing system, that the profile is unassociated with any other physical location; and deleting, by the computing system, the profile from a database so as to reduce consumption of computing resources.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

Having described several examples in detail, various modifications and improvements will readily occur to those skilled in the art. Such modifications and improvements are intended to be within the scope of this disclosure. Accordingly, the foregoing description is by way of example only, and is not intended as limiting.

1. A method comprising:
providing, by a security system, a suggestion that a subject be authorized to access a location;
receiving, by the security system, a confirmation that the subject is authorized to access the location;
after receipt of the confirmation, setting a profile to indicate authorization of the subject to access the location;
receiving, from an image capture device, an image acquired at the location, the image depicting the subject;
recognizing, by the security system, the subject in the image; and
refraining, by the security system in response to recognizing the subject and based on the profile, from initiating an alarm.

2. The method of claim 1, wherein:
the location is a first location linked with an account of a user of the security system; and
providing the suggestion that the subject be authorized to access the first location comprises determining that the subject is authorized to access a second location that is linked with the profile and that is physically distinct from the first location.

3. The method of claim 2, wherein determining that the subject is authorized to access the second location comprises determining that the second location is linked with the profile.

4. The method of claim 3, wherein determining that the second location is linked with the profile comprises locating an identifier of the second location within a record storing attributes of the profile.

5. The method of claim 4, wherein:
providing the suggestion that the subject be authorized to access the first location further comprises rendering a control associated with the profile within a screen while the first location is in context; and
receiving the confirmation that the subject is authorized to access the first location comprises receiving input selecting the control.

6. The method of claim 5, further comprising linking, in response to receiving the confirmation, the first location with the profile by storing an identifier of the first location in the record.

7. The method of claim 2, further comprising:
receiving a request to revoke authorization of the subject to access the second location; and
unlinking, in response to receiving the request, the second location from the profile.

8. The method of claim 7, wherein unlinking the second location from the profile comprises deleting an identifier of the second location from a record storing attributes of the profile.

9. The method of claim 7, wherein unlinking the second location from the profile comprises:
determining that the second location alone is linked with the profile; and
deleting a record storing attributes of the profile in response to determining that the second location alone is linked with the profile.

10. A system comprising:
a memory; and
at least one processor coupled with the memory and configured to
provide a suggestion that a subject be authorized to access a location,
receive a confirmation that the subject is authorized to access the location,
after receipt of the confirmation, set a profile to indicate authorization of the subject to access the location,
receive an image acquired at the location, the image depicting the subject,
recognize the subject in the image, and
refrain, in response to recognizing the subject and based on the profile, from initiating an alarm.

11. The system of claim 10, wherein:
the location is a first location linked with an account of a user; and
to provide the suggestion that the subject be authorized to access the first location comprises to determine that the subject is authorized to access a second location that is linked with the profile and that is physically distinct from the first location.

12. The system of claim 11, wherein:
to determine that the subject is authorized to access the second location comprises to determine that the second location is linked with the profile; and
to determine that the second location is linked with the profile comprises to locate an identifier of the second location within a record storing attributes of the profile.

13. The system of claim 12, wherein:
to provide the suggestion that the subject be authorized to access the first location further comprises to render a control associated with the profile within a screen while the first location is in context; and
to receive the confirmation that the subject is authorized to access the first location comprises to receive input selecting the control.

14. The system of claim 13, wherein:
the at least one processor is further configured to link, in response to receiving the confirmation, the first location with the profile; and
to link the first location with the profile comprises to store an identifier of the first location in the record.

15. The system of claim 12, wherein the at least one processor is further configured to:
render a screen representative of the profile while the second location is in context, the screen including a control to revoke authorization of the subject to access the second location;
receive, via the control, a request to revoke the authorization of the subject to access the second location; and
unlink, in response to reception of the request, the second location from the profile.

16. The system of claim 15, wherein to unlink the second location from the profile comprises to:
delete the identifier of the second location from the record storing attributes of the profile; or
based on determining that the second location alone is linked with the profile, delete the record.

17. One or more non-transitory computer readable media storing sequences of instructions executable by at least one processor to filter events based on profiles, the sequences of instructions comprising instructions to:
provide a suggestion that a subject be authorized to access a location,
receive a confirmation that the subject is authorized to access the location,
after receipt of the confirmation, set a profile to indicate authorization of the subject to access the location,
receive an image acquired at the location, the image depicting the subject,
recognize the subject in the image, and
refrain, in response to recognizing the subject and based on the profile, from initiating an alarm.

18. The one or more non-transitory computer readable media of claim 17, wherein:
the location is a first location linked with an account of a user; and
to provide the suggestion that the subject be authorized to access the first location comprises to determine that the subject is authorized to access a second location that is linked with the profile by locating an identifier of the second location within a record storing attributes of the profile.

19. The one or more non-transitory computer readable media of claim 18, wherein:
to provide the suggestion that the subject be authorized to access the first location further comprises to render a control associated with the profile within a screen while the first location is in context; and
to receive the confirmation that the subject is authorized to access the first location comprises to receive input selecting the control.

20. The one or more non-transitory computer readable media of claim 18, wherein the sequences of instructions further comprise instructions to:
receive a request to revoke authorization of the subject to access the second location; and
unlink, in response to reception of the request, the second location from the profile.
